(19) United States
(12) Patent Application Publication
(10) Pub. No.: US 2026/0327452 A1
(43) Pub. Date: Oct. 22, 2026

(54) A MULTI-LAYER COATING SYSTEM

(71) Applicant: PPG Industries Ohio, Inc., Cleveland, OH (US)

(72) Inventor: Benno Georg Buck, Cleveland, OH (US)

(73) Assignee: PPG Industries Ohio, Inc., Cleveland, OH (US)

(21) Appl. No.: 19/112,370

(22) PCT Filed: Sep. 19, 2023
(86) PCT No.: PCT/US2023/074549

§ 371 Date: Mar. 17, 2025

Related U.S. Application Data
(60) Provisional application No. 63/376,351, filed on Sep. 20, 2022.

(51) Int. Cl. C09D 163/00; B41M 5/00; B41M 5/52; B41M 7/00; B65D 65/42

(52) U.S. Cl. CPC C09D 163/00; B41M 5/0058; B41M 5/0064; B41M 5/5209; B41M 7/0045; B65D 65/42; B41M 2205/40

(57) ABSTRACT

A multi-layer coating system comprising: an undercoat coating layer derived from a UV curable undercoat coating composition, the UV curable undercoat coating composition comprising: al) an epoxy material; b1) a polyol material having a hydroxyl value (OHV) of at least 35 mg KOH/g and/or a diketone-functional material; and c1) a photoinitiator; and an ink layer disposed directly on the undercoat coating layer, said ink layer being derived from an ink composition. The invention extends to a multi-layer coating system for an aluminium package comprising an ink layer, said ink layer being derived from an ink composition; and an overcoat coating layer disposed directly on the ink layer, said overcoat coating layer derived from a UV curable overcoat coating composition, the UV curable overcoat coating composition comprising: a2) an epoxy material; b2) a polyol material and/or a diketone-functional material; and c2) a photoinitiator.

### FIELD

The present disclosure relates to a multi-layer coating systems comprising one or more coating layers in direct contact with an ink layer, such as a digitally printed ink layer. The coating layers in direct contact with the ink layer comprise an epoxy resin, a polyol material and a photoinitiator.

In particular, the present invention relates to a multi-layer coating system comprising an undercoat layer derived from a UV curable undercoat coating composition comprising an epoxy resin, a polyol material and a photoinitiator; an ink layer derived from an ink composition; and optionally a topcoat coating layer derived from a topcoat coating composition. The disclosure also extends to a package, such as a plastic package, coated on at least a portion thereof with said multi-layer coating system, and a method of producing such a package.

The invention also extends to a multi-layer coating system for an aluminium package comprising, optionally, a primer coating layer derived from a primer coating composition; an ink layer derived from an ink composition; and an overcoat coating layer derived from a UV curable overcoat coating composition comprising: an epoxy material; a polyol material and/or a diketone-functional material and a photoinitiator. The disclosure also extends to an aluminium package coated on at least a portion thereof with said multi-layer coating system, and a method of producing such a package.

### BACKGROUND

A variety of coatings are applied on the surface of packages, such as packages for food or beverages or for personal care products, to form a protective coating and/or decorative coating. For example, coatings may be applied to packaging formed from metal, including aluminium, or to packing formed from plastic, including polyethylene, polypropylene and/or polyethylene terephthalate. Coating compositions may be applied to the interior surface of packaging to protect the substrate (package) from the contents of the package, such as foods, toothpaste or personal care products, for example, that may be contained therein. Coating compositions may also be applied to the exterior surface of a metal or plastic or metal package, for example, to provide a decorative and/or protective coating.

Coating compositions can be applied onto an already formed plastic packaging, such as by spray coating and/or dip coating the part, and then curing. The coatings should be able to applied on the substrate at high speed, while also providing necessary performance to meet the needs of end users, for example, the formed coating layer should be safe for contact with the contents of the package, safe for contact with the end user, and/or have excellent adhesion to the substrate.

Typically after formation of a metal or plastic or metal package, a decorative coating may be applied. For example, an image may be printed onto a surface of the package using inks.

Optionally, an overcoat layer may also be applied on top of the printed image. Typically, offset printing, using conventional offset inks, has been used in the packaging industry. However, there is a move towards the use of digital printing to transfer an image directly onto the substate (package). It is necessary in any printing process to ensure that the resulting image has sufficient depth of colour and resolution as well as having good adhesion to the substrate.

Many of the coating compositions for food and beverage containers are based on epoxy resins that are based on polyglycidyl ethers of bisphenol A. Bisphenol A in packaging coatings either as bisphenol A itself (BPA), derivatives thereof, such as diglycidyl ethers of bisphenol A (BADGE), epoxy novolak resins and polyols prepared with bisphenol A and bisphenol F are problematic. Although the balance of scientific evidence available to date indicates that small trace amounts of BPA or BADGE that might be released from existing coatings does not pose health risks to humans, these compounds are nevertheless perceived by some as being harmful to human health. Consequently, there is a strong desire to eliminate these compounds from coatings for food and beverage containers. Accordingly, packaging coating compositions for food or beverage containers that do not contain extractable quantities of BPA, BADGE or other derivatives of BPA and yet have suitable properties for use in this application are therefore desired.

### SUMMARY

According to the present disclosure there is provided a multi-layer coating system comprising:
i) an undercoat coating layer derived from a UV curable undercoat coating composition, the UV curable undercoat coating composition comprising:
   a1) an epoxy material;
   b1) a polyol material having a hydroxyl value (OHV) of at least 35 mg KOH/g and/or a diketone-functional material; and
   c1) a photoinitiator;
ii) an ink layer disposed directly on the undercoat coating layer, said ink layer being derived from an ink composition, optionally wherein the ink composition is digitally printed; and
iii) optionally a topcoat coating layer disposed directly on the ink layer, said topcoat coating layer being derived from a topcoat coating composition.

There is also provided a package coated on at least a portion thereof with a multi-layer coating system comprising:
i) an undercoat coating layer derived from a UV curable undercoat coating composition, the UV curable undercoat coating composition comprising:
   a1) an epoxy material;
   b1) a polyol material having a hydroxyl value (OHV) of at least 35 mg KOH/g and/or a diketone-functional material; and
   c1) a photoinitiator; and
ii) an ink layer disposed directly on the undercoat coating layer, said ink layer being derived from an ink composition, optionally wherein the ink composition is digitally printed; and
iii) optionally a topcoat coating layer disposed directly on the ink layer, said topcoat coating layer being derived from a topcoat coating composition.

There is also provided a plastic package coated on at least a portion thereof with a multi-layer coating system comprising:
i) an undercoat coating layer derived from a UV curable undercoat coating composition, the UV curable undercoat coating composition comprising:
   a1) an epoxy material;
   b1) a polyol material having a hydroxyl value (OHV) of at least 35 mg KOH/g and/or a diketone-functional material; and
   c1) a photoinitiator;
ii) an ink layer disposed directly on the undercoat coating layer, said ink layer being derived from an ink composition, optionally wherein the ink composition is digitally printed; and
iii) optionally a topcoat coating layer disposed directly on the ink layer, said topcoat coating layer being derived from a topcoat coating composition.

There is also provided a method of producing a package, the method comprising the steps of:
I) applying a UV curable undercoat coating composition at least a portion of a package, the UV curable undercoat coating composition comprising:
   a1) an epoxy material;
   b1) a polyol material having a hydroxyl value (OHV) of at least 35 mg KOH/g and/or a diketone-functional material; and
   c1) a photoinitiator;
II) curing the UV curable undercoat coating composition to form a cured undercoat coating layer;
III) applying an ink composition, such as by digital printing, on at least a portion of the undercoat coating layer; and
IV) curing the ink composition to from an ink layer;
V) optionally applying a topcoat coating composition on at least a portion of the ink layer; and
VI) curing the topcoat coating composition, if present, to form a cured overcoat coating layer.

There is also provided a method of producing a plastic package, the method comprising the steps of:
I) applying a UV curable undercoat coating composition at least a portion of a plastic package, the UV curable undercoat coating composition comprising:
   a1) an epoxy material;
   b1) a polyol material having a hydroxyl value (OHV) of at least 35 mg KOH/g and/or a diketone-functional material; and
   c1) a photoinitiator;
II) curing the UV curable undercoat coating composition to form a cured undercoat coating layer;
III) applying an ink composition, such as by digital printing, on at least a portion of the undercoat coating layer; and
IV) curing the ink composition to from an ink layer;
V) optionally applying a topcoat coating composition on at least a portion of the ink layer; and
VI) curing the topcoat coating composition, if present, to form a cured overcoat coating layer.

There is also provided a multi-layer coating system for an aluminium package, such as an aluminium monobloc aerosol can and/or tube, comprising:
i) optionally a primer coating layer, said primer coating layer being derived from a primer coating composition;
ii) an ink layer disposed directly on the aluminium package and/or the primer coating layer, if present, said ink layer being derived from an ink composition, optionally wherein the ink composition is digitally printed; and
iii) an overcoat coating layer disposed directly on the ink layer, said overcoat coating layer derived from a UV curable overcoat coating composition, the UV curable overcoat coating composition comprising:
   a2) an epoxy material;
   b2) a polyol material and/or a diketone-functional material; and
   c2) a photoinitiator.

There is also provided an aluminium package, such as an aluminium monobloc aerosol can and/or tube, coated on at least a portion thereof with a multi-layer coating system comprising:
i) optionally a primer coating layer, said primer coating layer being derived from a primer coating composition;
ii) an ink layer disposed directly on the aluminium package and/or the primer coating layer, if present, said ink layer being derived from an ink composition, optionally wherein the ink composition is digitally printed; and
iii) an overcoat coating layer disposed directly on the ink layer, said overcoat coating layer derived from a UV curable overcoat coating composition, the UV curable overcoat coating composition comprising:
   a2) an epoxy material;
   b2) a polyol material and/or a diketone-functional material; and
   c2) a photoinitiator.

There is also provided a method of producing an aluminium package, such as an aluminium monobloc aerosol can and/or tube, the method comprising the steps of:
I) optionally applying a primer coating composition to at least a portion of an aluminium package;
II) curing the undercoat coating composition, if present, to form a cured undercoat coating layer;
III) applying an ink composition, such as by digital printing, on at least a portion of the aluminium package or, if present, the primer coating layer;
IV) curing the ink composition to from an ink layer;
V) applying a UV curable overcoat coating composition comprising:
   a2) an epoxy material;
   b2) a polyol material and/or a diketone-functional material; and
   c2) a photoinitiator; and
VI) curing the UV curable overcoat coating composition to form a cured overcoat coating layer.

### DETAILED DESCRIPTION

### UV Curable Undercoat Coating Composition

The multi-layer coating system may comprise an undercoat coating layer derived from a UV curable undercoat coating composition comprising an epoxy material, a polyol material and/or a diketone-functional material, and a photoinitiator. The terms “UV curable undercoat coating composition” and “undercoat coating composition” may be used interchangeably herein. Any reference to “undercoat coating composition” should be construed as said undercoat coating composition being UV curable, unless specified otherwise. By “UV-curable”, and like terms as used herein, is meant that a coating composition may be cured, i.e., caused to harden to form a coating (or film), by exposure to ultraviolet (UV) radiation.

The UV curable undercoat coating composition comprises an epoxy material. The epoxy material may be any suitable epoxy material. By “epoxy material”, and like terms as used herein, is meant a material that includes at least one pendant and/or terminal oxirane group.

The epoxy material may comprise an aliphatic epoxy resin, a cycloaliphatic epoxy resin and/or an aromatic epoxy resins. Examples of suitable epoxy resins include, but are not limited to, epoxy-functional acrylic resins, 1,2 propanediol diglycidyl ether, 1,4-butanediol diglycidyl ether, 1,6-hexanediol diglycidyl ether, poly(propylene glycol) diglycidyl ether, 1,4-cyclohexanedmethanol diglycidyl ether, 1,3-cyclohexanedmethanol diglycidyl ether, 3′,4′-epoxycyclohexymethyl-3,4-epoxycyclohexanecarboxylate, 3,4-epoxycyclohexyloxirane, 2-(3′,4′-epoxycyclohexyl)-5,1″-spiro-3″,4″-epoxycyclohexane-1,3-dioxane, vinyl cyclohexene monoxide, bis(3,4-epoxycyclohexylmethyl) adipate, the diglycidyl ether of cardanol, the diglycidyl ester of phthalic acid, the diglycidyl ester of hexahydrophthalic acid, diglycidyl ether of bisphenol A (DGEBA), solid epoxy resins based on DGEBA, phenoxy resins, the diglycidyl ether of bisphenol F, epoxy novolac resins, cresol epoxy novolacs and combinations thereof.

The epoxy material may comprise a cycloaliphatic epoxy resin.

The epoxy material may comprise 3′,4′-epoxycyclohexymethyl-3,4-epoxycyclohexanecarboxylate, 1,4-butanediol diglycidyl ether, bis(3,4-epoxycyclohexylmethyl) adipate, 1,6-hexanediol diglycidyl ether and/or combinations thereof.

The epoxy material may comprise a commercially available epoxy material. Examples of suitable commercially available epoxy materials include, but are not limited to, those sold under the tradename UviCure® commercially available from Lambson, such as UviCure S105, UviCure S105E and UviCure S128; those sold under the tradename D.E.R.® commercially available from Olin Epoxy, such as D.E.R. 721, D.E.R. 723, D.E.R. 727, D.E.R. 732, D.E.R. 736, and D.E.R. 741; those sold under the tradename Cardolite® commercially available from Cardolite, such as Cardolite NC-547, NC-513, LITE 513E, Ultra LITE 513, NC-514 and NC-514S; and combinations thereof.

The epoxy material may be present in any suitable amount. The UV curable undercoat coating composition may comprise at least 20 wt %, such as at least 30 wt %, such as at least 40 wt %, such as at least 50 wt %, such as at least 55 wt %, such as at least 60 wt %, such as at least 65 wt % epoxy material based on the total solid weight of the UV curable undercoat coating composition. The UV curable undercoat coating composition may comprise up to 99 wt %, such as up to 95 wt %, such as up to 90 wt %, such as up to 85 wt %, such as up to 80 wt %, such as up to 75 wt % epoxy material based on the total solid weight of the UV curable undercoat coating composition.

The UV curable undercoat coating composition may comprise from 20 to 99 wt %, such as from 30 to 99 wt %, such as from 40 to 99 wt %, such as from 50 to 99 wt %, such as from 55 to 99 wt %, such as from 60 to 99 wt %, such as from 65 to 99 wt % epoxy material based on the total solid weight of the UV curable undercoat coating composition. The UV curable undercoat coating composition may comprise from 20 to 95 wt %, such as from 30 to 95 wt %, such as from 40 to 95 wt %, such as from 50 to 95 wt %, such as from 55 to 95 wt %, such as from 60 to 95 wt %, such as from 65 to 95 wt % epoxy material based on the total solid weight of the UV curable undercoat coating composition. The UV curable undercoat coating composition may comprise from 20 to 90 wt %, such as from 30 to 90 wt %, such as from 40 to 90 wt %, such as from 50 to 90 wt %, such as from 55 to 90 wt %, such as from 60 to 90 wt %, such as from 65 to 90 wt % epoxy material based on the total solid weight of the UV curable undercoat coating composition. The UV curable undercoat coating composition may comprise from 20 to 85 wt %, such as from 30 to 85 wt %, such as from 40 to 85 wt %, such as from 50 to 85 wt %, such as from 55 to 85 wt %, such as from 60 to 85 wt %, such as from 65 to 85 wt % epoxy material based on the total solid weight of the UV curable undercoat coating composition. The UV curable undercoat coating composition may comprise from 20 to 80 wt %, such as from 30 to 80 wt %, such as from 40 to 80 wt %, such as from 50 to 80 wt %, such as from 55 to 80 wt %, such as from 60 to 80 wt %, such as from 65 to 80 wt % epoxy material based on the total solid weight of the UV curable undercoat coating composition. The UV curable undercoat coating composition may comprise from 20 to 75 wt %, such as from 30 to 75 wt %, such as from 40 to 75 wt %, such as from 50 to 75 wt %, such as from 55 to 75 wt %, such as from 60 to 75 wt %, such as from 65 to 75 wt % epoxy material based on the total solid weight of the UV curable undercoat coating composition.

The UV curable undercoat coating composition may comprise from 50 to 90 wt % epoxy material based on the total solid weight of the UV curable undercoat coating composition.

The UV curable undercoat coating composition may comprise from 55 to 85 wt % epoxy material based on the total solid weight of the UV curable undercoat coating composition.

The UV curable undercoat coating composition may comprise from 60 to 80 wt % epoxy material based on the total solid weight of the UV curable undercoat coating composition.

The UV curable undercoat coating composition may comprise from 65 to 75 wt % epoxy material based on the total solid weight of the UV curable undercoat coating composition.

The UV curable undercoat coating composition may comprise a polyol material having a hydroxyl value (OHV) of at least 35 mg KOH/g. The polyol material may be any suitable polyol material (on the proviso that it has a hydroxyl value (OHV) of at least 35 mg KOH/g).

“Polyol” and like terms, as used herein, refers to a compound having two or more hydroxyl groups, such as two, three, four etc. hydroxyl groups. The hydroxyl groups of the polyol material may be connected by a bridging group selected from: an alkylene group; an alkenylene group; an alkynylene group; or an arylene group. The polyol material may be an organic polyol material.

Examples of suitable polyol materials include, but are not limited to, polyethylene glycol, polypropylene glycol, polycaprolactone, hydroxy-functional polymers, such as hydroxy-functional polyester, acrylic, polyether, alkyd, vinyl, polyurethane and/or a polysiloxane resins; hydroxy-functional dendritic polymers, such as fatty acid-modified dendritic polymers having two or more, such as 2, 3, 4, 5, 6 or more, terminal hydroxyl groups; alkoxylated ether polyols; and/or a combination thereof.

The polyol material may comprise a hydroxy-functional polyester resin.

The polyol material may comprise a polycaprolactone.

The polyol material may comprise polypropylene glycol.

The polyol material may comprise a fatty acid-modified dendritic polymer having two or

more terminal hydroxy groups, such as 2 to 6 terminal hydroxy groups, such as 4 to 6 terminal hydroxy groups, such as 6 terminal hydroxy groups.

The polyol material may comprise a hydroxy-functional vinyl resin.

The polyol material may comprise a commercially available polyol material. Examples of suitable commercially available polyol materials include, but are not limited to, those sold under the tradename Desmophen® commercially available from Covestro, such as Desmophen 1380, Desmophen 1652, Desmophen C1200, Desmophen 1700, Desmophen 850, Desmophen 1800 and Desmophen 670; those available under the tradename Capa® commercially available from Perstorp, such as Capa 3031, Capa 4104, Capa 2043, Capa 3091, Capa 2065, Capa 2205 and Capa 2054; those sold under the tradename K-Flex® commercially available from King Industries, such as K-flex 337 BA; those sold under the tradename Boltorn® commercially available from Perstorp, such as Bolthorn H 2004, Boltorn 4311, Boltorn P1000 and Boltorn P500; Polyol 4290 commercially available from Perstorp; those sold under the tradename Nebores® commercially available from Safic-Alcan, such as Nebores VAGH; and combinations thereof.

The polyol material may comprise a commercially available hydroxy-functional polyester resin. Suitable commercially available hydroxy-functional polyester resins include, but are not limited to, those sold under the tradename Tego® commercially available from Evonik, such as Tego Addbond LP 1600, LP1611, LTW, LTW-B, LTH, 2440 and 2325; those sold under the trade name URALAC® commercially available from DSM, such as URALAC P1580; and combinations thereof.

The polyol material may have an OHV of at least 40 mg KOH/g, such as at least 45 mg KOH/g, such as at least 50 mg KOH/g, such as at least 55 mg KOH/g, such as at least 60 mg KOH/g, such as at least 70 KOH/g, such as at least 80 KOH/g, such as at least 90 KOH/g, such as at least 100 mg KOH/g, such as at least 110 KOH/g, such as at least 120 KOH/g, such as at least 130 KOH/g, such as at least 140 KOH/g, such as at least 150 mg KOH/g, such as at least 200 mg KOH/g, such as at least 250 mg KOH/g. The polyol material may have an OHV of up to 650 mg KOH/g, such as up to 600 mg KOH/g, such as up to 550 mg KOH/g, such as up to 500 mg KOH/g, such as up to 450 mg KOH/g, such as up to 400 mg KOH/g.

The polyol material may have an OHV from 35 to 650 mg KOH/g, such as from 40 to 650 mg KOH/g, such as from 45 to 650 mg KOH/g, such as from 50 to 650 mg KOH/g, such as from 55 to 650 mg KOH/g, such as from 60 to 650 mg KOH/g, such as from 70 to 650 KOH/g, such as from 80 to 650 KOH/g, such as from 90 to 650 KOH/g, such as from 100 to 650 mg KOH/g, such as from 110 to 650 KOH/g, such as from 120 to 650 KOH/g, such as from 130 to 650 KOH/g, such as from 140 to 650 KOH/g, such as from 150 to 650 mg KOH/g, such as from 200 to 650 mg KOH/g, such as from 250 to 650 mg KOH/g. The polyol material may have an OHV from 35 to 600 mg KOH/g, such as from 40 to 600 mg KOH/g, such as from 45 to 600 mg KOH/g, such as from 50 to 600 mg KOH/g, such as from 55 to 600 mg KOH/g, such as from 60 to 600 mg KOH/g, such as from 70 to 600 KOH/g, such as from 80 to 600 KOH/g, such as from 90 to 600 KOH/g, such as from 100 to 600 mg KOH/g, such as from 110 to 600 KOH/g, such as from 120 to 600 KOH/g, such as from 130 to 600 KOH/g, such as from 140 to 600 KOH/g, such as from 150 to 600 mg KOH/g, such as from 200 to 600 mg KOH/g, such as from 250 to 600 mg KOH/g. The polyol material may have an OHV from 35 to 550 mg KOH/g, such as from 40 to 550 mg KOH/g, such as from 45 to 550 mg KOH/g, such as from 50 to 550 mg KOH/g, such as from 55 to 550 mg KOH/g, such as from 60 to 550 mg KOH/g, such as from 70 to 550 KOH/g, such as from 80 to 550 KOH/g, such as from 90 to 550 KOH/g, such as from 100 to 550 mg KOH/g, such as from 110 to 550 KOH/g, such as from 120 to 550 KOH/g, such as from 130 to 550 KOH/g, such as from 140 to 550 KOH/g, such as from 150 to 550 mg KOH/g, such as from 200 to 550 mg KOH/g, such as from 250 to 550 mg KOH/g. The polyol material may have an OHV from 35 to 500 mg KOH/g, such as from 40 to 500 mg KOH/g, such as from 45 to 500 mg KOH/g, such as from 50 to 500 mg KOH/g, such as from 55 to 500 mg KOH/g, such as from 60 to 500 mg KOH/g, such as from 70 to 500 KOH/g, such as from 80 to 500 KOH/g, such as from 90 to 500 KOH/g, such as from 100 to 500 mg KOH/g, such as from 110 to 500 KOH/g, such as from 120 to 500 KOH/g, such as from 130 to 500 KOH/g, such as from 140 to 500 KOH/g, such as from 150 to 500 mg KOH/g, such as from 200 to 500 mg KOH/g, such as from 250 to 500 mg KOH/g. The polyol material may have an OHV from 35 to 450 mg KOH/g, such as from 40 to 450 mg KOH/g, such as from 45 to 450 mg KOH/g, such as from 50 to 450 mg KOH/g, such as from 55 to 450 mg KOH/g, such as from 60 to 450 mg KOH/g, such as from 70 to 450 KOH/g, such as from 80 to 450 KOH/g, such as from 90 to 450 KOH/g, such as from 100 to 450 mg KOH/g, such as from 110 to 450 KOH/g, such as from 120 to 450 KOH/g, such as from 130 to 450 KOH/g, such as from 140 to 450 KOH/g, such as from 150 to 450 mg KOH/g, such as from 200 to 450 mg KOH/g, such as from 250 to 450 mg KOH/g. The polyol material may have an OHV from 35 to 400 mg KOH/g, such as from 40 to 400 mg KOH/g, such as from 45 to 400 mg KOH/g, such as from 50 to 400 mg KOH/g, such as from 55 to 400 mg KOH/g, such as from 60 to 400 mg KOH/g, such as from 70 to 400 KOH/g, such as from 80 to 400 KOH/g, such as from 90 to 400 KOH/g, such as from 100 to 400 mg KOH/g, such as from 110 to 400 KOH/g, such as from 120 to 400 KOH/g, such as from 130 to 400 KOH/g, such as from 140 to 400 KOH/g, such as from 150 to 400 mg KOH/g, such as from 200 to 400 mg KOH/g, such as from 250 to 400 mg KOH/g.

The polyol material may have a hydroxyl value of at least 50 mg KOH/g.

The polyol material may have a hydroxyl value of at least 100 mg KOH/g.

The gross hydroxyl value, as reported herein, is expressed on solids.

As reported herein, the hydroxyl value expressed on solids is the number of mg of KOH equivalent to the hydroxyl groups in 1 g of material. In such as method, a sample (typically, 0.1 to 3 g) was weighed accurately into a conical flask and is dissolved, using light heating and stirring as appropriate, in 20 ml of tetrahydrofuran. 10 ml of 0.1 M 4-(dimethylamino)pyridine in tetrahydrofuran (catalyst solution) and 5 ml of a 9 vol % solution of acetic anhydride in tetrahydrofuran (i.e. 90 ml acetic anhydride in 910 ml tetrahydrofuran; acetylating solution) were then added to the mixture. After 5 minutes, 10 ml of an 80 vol % solution of tetrahydrofuran (i.e. 4 volume parts tetrahydrofuran to 1 part distilled water; hydrolysis solution) was added. After 15 minutes, 10 ml tetrahydrofuran was added and the solution is titrated with 0.5 M ethanolic potassium hydroxide (KOH). A blank sample was also run where the sample of solid polyester is omitted. The resulting hydroxyl value is expressed in units of mg KOH/g and is calculated using the following equation:

Hydroxyl value=((V₂−V₁)×molarity of KOH solution (M)×56.1)/weight of solid sample (g)
wherein V₁ is the titre of KOH solution (ml) of the polyester sample and V₂ is the titre of KOH solution (ml) of the blank sample. All values for hydroxyl value reported herein were measured in this way.

The polyol material may have any suitable acid value (AV; also known as acid number or AN). The polyol material may have an acid value up to 20 mg KOH/g, such as up to 10 mg KOH/g, such as up to 5 mg KOH/g, such as up to 4 mg KOH/g, such as up to 3 mg KOH/g, such as up to 2 mg KOH/g, such as up to 1 mg KOH/g.

The acid value as reported herein is expressed on solids.

As reported herein, the acid value (AV) expressed on solids was determined by titration with 0.1 M methanolic potassium hydroxide (KOH) solution. A sample of solid polymer (0.1 to 3 g depending on acid number) was weighed accurately into a conical flask and is dissolved, using light heating and stirring as appropriate, in 25 ml of dimethyl formamide containing phenolphthalein indicator. The solution was then cooled to room temperature and titrated with the 0.1 M methanolic potassium hydroxide solution. The resulting acid number is expressed in units of mg KOH/g and is calculated using the following equation:

$$Acid value = \frac{titre of KOH solution ( ml ) \times molarity KOH solution ( M ) \times 56.1}{weight of solid sample ( g )}$$

All values for acid value reported herein were measured in this way.

The polyol material may have any suitable number-average molecular weight (Mn). The polyol material may have an Mn of at least 100 Daltons (Da=g/mole), such as at least 200 Da, such as at least 250 Da, such as at least 300 Da. The polyol material may have an Mn up to 50,000 Da, such as up to 25,000 Da, such as up to 20,000 Da, such as up to 10,000 Da, such as up to 5,000 Da, such as up to 4,500 Da, such as up to 4,000 Da, such as up to 3,500 Da.

The polyol material may have an Mn from 100 to 50,000 Da, such as from 200 to 50,000 Da, such as from 250 to 50,000 Da, such as from 300 to 50,000 Da. The polyol material may have an Mn from 100 to 25,000 Da, such as from 200 to 25,000 Da, such as from 250 to 25,000 Da, such as from 300 to 25,000 Da. The polyol material may have an Mn from 100 to 20,000 Da, such as from 200 to 20,000 Da, such as from 250 to 20,000 Da, such as from 300 to 20,000 Da. The polyol material may have an Mn from 100 to 10,000 Da, such as from 200 to 10,000 Da, such as from 250 to 10,000 Da, such as from 300 to 10,000 Da. The polyol material may have an Mn from 100 to 5,000 Da, such as from 200 to 5,000 Da, such as from 250 to 5,000 Da, such as from 300 to 5,000 Da. The polyol material may have an Mn from 100 to 4,500 Da, such as from 200 to 4,500 Da, such as from 250 to 4,500 Da, such as from 300 to 4,500 Da. The polyol material may have an Mn from 100 to 4,000 Da, such as from 200 to 4,000 Da, such as from 250 to 4,000 Da, such as from 300 to 4,000 Da. The polyol material may have an Mn from 100 to 3,500 Da, such as from 200 to 3,500 Da, such as from 250 to 3,500 Da, such as from 300 to 3,500 Da. The polyol material may have an Mn from 100 to 3,000 Da, such as from 200 to 3,000 Da, such as from 250 to 3,000 Da, such as from 300 to 3,000 Da.

The polyol material may have a number average molecular weight (Mn) up to 5,000 Da.

The polyol material may have a number average molecular weight (Mn) up to 4,000 Da.

The polyol material may have a number average molecular weight (Mn) up to 3,500 Da.

The polyol material may have any suitable weight-average molecular weight (Mw).

The polyol material may be a low molecular weight polyol material. By “low molecular weight”, and like terms as used herein in relation to the polyol material, is meant a polyol material having an Mn up to 5,000 Da.

As reported herein, the Mn may be determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”. UV detector; 254 nm, solvent: unstabilised THF, retention time marker: toluene, sample concentration: 2 mg/ml). All values for Mn reported herein were measured in this way.

The polyol material may have any suitable weight-average molecular weight (Mw). The polyol material may have an Mw of at least 100 Daltons (Da=g/mole), such as at least 200 Da, such as at least 250 Da, such as at least 300 Da. The polyol material may have an Mw up to 50,000 Da, such as up to 25,000 Da, such as up to 20,000 Da, such as up to 10,000 Da, such as up to 5,000 Da, such as up to 4,500 Da, such as up to 4,000 Da, such as up to 3,500 Da.

The polyol material may have an Mw from 100 to 50,000 Da, such as from 200 to 50,000 Da, such as from 250 to 50,000 Da, such as from 300 to 50,000 Da. The polyol material may have an Mw from 100 to 25,000 Da, such as from 200 to 25,000 Da, such as from 250 to 25,000 Da, such as from 300 to 25,000 Da. The polyol material may have an Mw from 100 to 20,000 Da, such as from 200 to 20,000 Da, such as from 250 to 20,000 Da, such as from 300 to 20,000 Da. The polyol material may have an Mw from 100 to 10,000 Da, such as from 200 to 10,000 Da, such as from 250 to 10,000 Da, such as from 300 to 10,000 Da. The polyol material may have an Mw from 100 to 5,000 Da, such as from 200 to 5,000 Da, such as from 250 to 5,000 Da, such as from 300 to 5,000 Da. The polyol material may have an Mw from 100 to 4,500 Da, such as from 200 to 4,500 Da, such as from 250 to 4,500 Da, such as from 300 to 4,500 Da. The polyol material may have an Mw from 100 to 4,000 Da, such as from 200 to 4,000 Da, such as from 250 to 4,000 Da, such as from 300 to 4,000 Da. The polyol material may have an Mw from 100 to 3,500 Da, such as from 200 to 3,500 Da, such as from 250 to 3,500 Da, such as from 300 to 3,500 Da. The polyol material may have an Mw from 100 to 3,000 Da, such as from 200 to 3,000 Da, such as from 250 to 3,000 Da, such as from 300 to 3,000 Da.

The polyol material may have a number average molecular weight (Mw) up to 5,000 Da.

The polyol material may have a number average molecular weight (Mw) up to 4,000 Da.

The polyol material may have a number average molecular weight (Mw) up to 3,500 Da. The polyol material may have any suitable weight-average molecular weight (Mw).

A person skilled in the art will appreciate that techniques to measure the number-average molecular weight may also be applied to measure the weight-average molecular weight.

The UV curable undercoat coating composition may comprise a diketone-functional material. The diketone-functional material may be any suitable diketone-functional material.

“Diketone-functional”, and like terms as used herein, refers to compounds having a —(O)ₘ—C(O)—(CH₂)ₙ—C(O)—R group, wherein m is 0 or 1; n is from 1-20, such as from 1-10, such as from 1-8, such as from 1-6, such as from 1-4, such as from 1-3, such as 1 or 2, such as 1; and R is hydrogen or an alkyl, alkenyl, alkynyl or aryl group.

m may be 1, such that the diketone functional group is of the formula —O—C(O)—(CH₂)ₙ—C(O)—R, wherein each of n and R are as defined hereinabove.

m may be 1, n may be 1 and R may be methyl, such that the diketone functional group is of the formula —O—C(O)—CH₂—C(O)—CH₃. As such, the diketone functional group may be an acetoacetate group.

The diketone-functional material may comprise an acetoacetate-functional material.

The diketone functional material may comprise a commercially available diketone-functional material. Examples of suitable commercially available diketone-functional materials include, but are not limited to, those sold under the tradename K-Flex® commercially available from King Industries, such as K-flex 7301 and K-flex XM B301.

The diketone-functional material may have any suitable diketone equivalent weight. The diketone-functional material may have a diketone equivalent weight of at least 50 g/eq, such as at least 60 g/eq, such as at least 70 g/eq, such as at least 80 g/eq, such as at least 90 g/eq, such as at least 100 g/eq, such as at least 110 g/eq, such as at least 120 g/eq, such as at least 130 g/eq, such as at least 140 g/eq, such as at least 150 g/eq, such as at least 160 g/eq, such as at least 170 g/eq. such as at least 180 g/eq, such as at least 190 g/eq.

The diketone-functional material may have a diketone equivalent weight of at least 120 g/eq.

The diketone-functional material may have a diketone equivalent weight of at least 180 g/eq.

When the diketone-functional material comprises an acetoacetate-functional material, the acetoacetate-functional material may have any suitable acetoacetate (AcAc) equivalent weight. The acetoacetate-functional material may have an AcAc equivalent weight of at least 50 g/eq, such as at least 60 g/eq, such as at least 70 g/eq, such as at least 80 g/eq, such as at least 90 g/eq, such as at least 100 g/eq, such as at least 110 g/eq, such as at least 120 g/eq, such as at least 130 g/eq, such as at least 140 g/eq, such as at least 150 g/eq, such as at least 160 g/eq, such as at least 170 g/eq. such as at least 180 g/eq, such as at least 190 g/eq.

The acetoacetate-functional material may have an AcAc equivalent weight of at least 120 g/eq.

The acetoacetate-functional material may have an AcAc equivalent weight of at least 180 g/eq.

When the UV curable undercoat coating composition comprises a polyol material, the UV curable undercoat coating composition may comprise at least 2 wt % polyol material based on the total solid weight of the UV curable undercoat coating composition. The UV curable undercoat coating composition may comprise at least 3 wt %, such as at least 4 wt %, such as at least 5 wt % polyol material based on the total solid weight of the UV curable undercoat coating composition. The UV curable undercoat coating composition may comprise up to 80 wt %, such as up to 70 wt %, such as up to 60 wt %, such as up to 50 wt %, such as up to 40 wt %, such as up to 30 wt %, such as up to 20 wt %, such as up to 15 wt % polyol material based on the total solid weight of the UV curable undercoat coating composition.

The UV curable undercoat coating composition may comprise from 2 to 80 wt %, such as from 2 to 70 wt %, such as from 2 to 60 wt %, such as from 2 to 50 wt %, such as from 2 to 40 wt %, such as from 2 to 30 wt %, such as from 2 to 20 wt %, such as from 2 to 15 wt % polyol material based on the total solid weight of the UV curable undercoat coating composition. The UV curable undercoat coating composition may comprise from 3 to 80 wt %, such as from 3 to 70 wt %, such as from 3 to 60 wt %, such as from 3 to 50 wt %, such as from 3 to 40 wt %, such as from 3 to 30 wt %, such as from 3 to 20 wt %, such as from 3 to 15 wt % polyol material based on the total solid weight of the UV curable undercoat coating composition. The UV curable undercoat coating composition may comprise from 4 to 80 wt %, such as from 4 to 70 wt %, such as from 4 to 60 wt %, such as from 4 to 50 wt %, such as from 4 to 40 wt %, such as from 4 to 30 wt %, such as from 4 to 20 wt %, such as from 4 to 15 wt % polyol material based on the total solid weight of the UV curable undercoat coating composition. The UV curable undercoat coating composition may comprise from 5 to 80 wt %, such as from 5 to 70 wt %, such as from 5 to 60 wt %, such as from 5 to 50 wt %, such as from 5 to 40 wt %, such as from 5 to 30 wt %, such as from 5 to 20 wt %, such as from 5 to 15 wt % polyol material based on the total solid weight of the UV curable undercoat coating composition.

The UV curable undercoat coating composition may comprise at least 5 wt % polyol material based on the total solid weight of the UV curable undercoat coating composition.

The UV curable undercoat coating composition may comprise from 5 to 30 wt % polyol material based on the total solid weight of the UV curable undercoat coating composition.

The UV curable undercoat coating composition may comprise from 5 to 20 wt % polyol material based on the total solid weight of the UV curable undercoat coating composition.

The UV curable undercoat coating composition may comprise from 5 to 15 wt % polyol material based on the total solid weight of the UV curable undercoat coating composition.

When the UV curable undercoat coating composition comprises a diketone-functional material, the UV curable undercoat coating composition may comprise at least 2 wt % diketone-functional material based on the total solid weight of the UV curable undercoat coating composition. The UV curable undercoat coating composition may comprise at least 3 wt %, such as at least 4 wt %, such as at least 5 wt % diketone-functional material based on the total solid weight of the UV curable undercoat coating composition. The UV curable undercoat coating composition may comprise up to 80 wt %, such as up to 70 wt %, such as up to 60 wt %, such as up to 50 wt %, such as up to 40 wt %, such as up to 30 wt %, such as up to 20 wt %, such as up to 15 wt % diketone-functional material based on the total solid weight of the UV curable undercoat coating composition.

The UV curable undercoat coating composition may comprise from 2 to 80 wt %, such as from 2 to 70 wt %, such as from 2 to 60 wt %, such as from 2 to 50 wt %, such as from 2 to 40 wt %, such as from 2 to 30 wt %, such as from 2 to 20 wt %, such as from 2 to 15 wt % diketone-functional material based on the total solid weight of the UV curable undercoat coating composition. The UV curable undercoat coating composition may comprise from 3 to 80 wt %, such as from 3 to 70 wt %, such as from 3 to 60 wt %, such as from 3 to 50 wt %, such as from 3 to 40 wt %, such as from 3 to 30 wt %, such as from 3 to 20 wt %, such as from 3 to 15 wt % diketone-functional material based on the total solid weight of the UV curable undercoat coating composition. The UV curable undercoat coating composition may comprise from 4 to 80 wt %, such as from 4 to 70 wt %, such as from 4 to 60 wt %, such as from 4 to 50 wt %, such as from 4 to 40 wt %, such as from 4 to 30 wt %, such as from 4 to 20 wt %, such as from 4 to 15 wt % diketone-functional material based on the total solid weight of the UV curable undercoat coating composition. The UV curable undercoat coating composition may comprise from 5 to 80 wt %, such as from 5 to 70 wt %, such as from 5 to 60 wt %, such as from 5 to 50 wt %, such as from 5 to 40 wt %, such as from 5 to 30 wt %, such as from 5 to 20 wt %, such as from 5 to 15 wt % diketone-functional material based on the total solid weight of the UV curable undercoat coating composition.

The UV curable undercoat coating composition may comprise at least 5 wt % diketone-functional material based on the total solid weight of the UV curable undercoat coating composition.

The UV curable undercoat coating composition may comprise from 5 to 30 wt % diketone-functional material based on the total solid weight of the UV curable undercoat coating composition.

The UV curable undercoat coating composition may comprise from 5 to 20 wt % diketone-functional material based on the total solid weight of the UV curable undercoat coating composition.

The UV curable undercoat coating composition may comprise from 5 to 15 wt % diketone-functional material based on the total solid weight of the UV curable undercoat coating composition.

The UV curable undercoat coating composition comprises a photoinitiator. By “photoinitiator”, and like terms as used herein, is meant a molecule that creates reactive species (e.g., cations) when exposed to radiation, e.g., UV. The reactive species may initiate the polymerization process to cure the composition.

The photoinitiator may be formed from any suitable photoinitiator. The photoinitiator may comprise a cationic photoinitiator. Examples of suitable photoinitiators include, but are not limited to, sulfonium salts, such as triphenylsulfonium salts and sulfonium hexafluoroantimonate; diazonium salts; iodonium salts, such as diaryliodonium salts; ferrocenium salts; other metallocene compounds; isobutyl benzoin ether; mixtures of butyl isomers of butyl benzoin ether; α,α-diethoxyacetophenone; α,α-dimethoxy-α-phenylacetophenone; ethyl benzoin ether; isopropyl benzoin ether; butyl benzoin ether; isobutyl benzoin ether; α,α-diethoxy-α-phenylacetophenone; 4,4′-dicarboethoxybenzoin ethyl ether; benzoin phenyl ether; α-methylbenzoin ethyl ether; α-methylolbenzoin methyl ether; α,α,α-trichloroacetophenone; and combinations thereof.

The photoinitiator may comprise a cationic photoinitiator.

The photoinitiator may comprise a sulfonium salt, such as sulfonium hexafluoroantimonate.

The photoinitiator may have any suitable absorption maxima. The photoinitiator may have an absorption maxima at 291 and/or 279 nm, such as at 291 and 279 nm.

The photoinitiator may be present in the UV curable undercoat coating composition any suitable amount. The UV curable undercoat coating composition may comprise at least 0.1 wt %, such as at least 0.5 wt %, such as at least 1 wt % photoinitiator based on the total solid weight of the UV curable undercoat coating composition. The UV curable undercoat coating composition may comprise up to 20 wt %, such as up to 15 wt %, such as up to 10 wt %, such as up to 5 wt %, such as up to 4 wt %, such as up to 3 wt %, such as up to 2 wt % photoinitiator based on the total solid weight of the UV curable undercoat coating composition.

The UV curable undercoat coating composition may comprise from 0.1 to 20 wt %, such as from 0.1 to 15 wt %, such as from 0.1 to 10 wt %, such as from 0.1 to 5 wt %, such as from 0.1 to 4 wt %, such as from 0.1 to 3 wt %, such as from 0.1 to 2 wt % photoinitiator based on the total solid weight of the UV curable undercoat coating composition. The UV curable undercoat coating composition may comprise from 0.5 to 20 wt %, such as from 0.5 to 15 wt %, such as from 0.5 to 10 wt %, such as from 0.5 to 5 wt %, such as from 0.5 to 4 wt %, such as from 0.5 to 3 wt %, such as from 0.5 to 2 wt % photoinitiator based on the total solid weight of the UV curable undercoat coating composition. The UV curable undercoat coating composition may comprise from 1 to 20 wt %, such as from 1 to 15 wt %, such as from 1 to 10 wt %, such as from 1 to 5 wt %, such as from 1 to 4 wt %, such as from 1 to 3 wt %, such as from 1 to 2 wt % photoinitiator based on the total solid weight of the UV curable undercoat coating composition.

The UV curable undercoat coating composition may comprise from 1 to 5 wt % photoinitiator based on the total solid weight of the UV curable undercoat coating composition.

The UV curable undercoat coating composition may comprise from 1 to 2 wt % photoinitiator based on the total solid weight of the UV curable undercoat coating composition.

The UV curable undercoat coating composition may further comprise a polyester material.

The polyester material may have a hydroxyl value (OHV) of less than 35 mg KOH/g, such as up to 30 mg KOH/g. The polyester material may have an OHV of at least 0 mg KOH/g, such as at least 5 mg KOH/g, such as at least 10 mg KOH/g, such as at least 15 mg KOH/g, such as at least 20 mg KOH/g.

The polyester material may have an OHV from 0 to less than 35 mg KOH/g, such as from 5 to less than 35 mg KOH/g, such as from 10 to less than 35 mg KOH/g, such as from 15 to less than 35 mg KOH/g, such as from 20 to less than 35 mg KOH/g. The polyester material may have an OHV from 0 to 30 mg KOH/g, such as from 5 to 30 mg KOH/g, such as from 10 to 30 mg KOH/g, such as from 15 to 30 mg KOH/g, such as from 20 to 30 mg KOH/g.

The polyester material may have an OHV up to 30 mg KOH/g.

The polyester material may have an OHV from 20 to 30 mg KOH/g.

For the avoidance of doubt, the UV curable undercoat coating composition may comprise a polyol material comprising a hydroxy-functional polyester resin and a further polyester material. It will be appreciated by a person skilled in the art that a polyester resin having an OHV of at least 35 mg KOH/g should be construed as a polyol material. In contrast, a polyester resin having an OHV of less than 35 mg KOH/g, such as up to 30 mg KOH/g, should be construed as a further polyester material.

The polyester material may comprise the reaction product of a polyacid and a polyol.

“Polyacid” and like terms as used herein, refers to a compound having two or more carboxylic acid groups, such as two, three or four acid groups, and includes an ester of the polyacid (wherein one or more of the acid groups is esterified) or an anhydride. The polyacid is an organic polyacid.

The carboxylic acid groups of the polyacid may be connected by a bridging group selected from: an alkylene group; an alkenylene group; an alkynylene group; or an arylene group.

The polyester material may be formed from any suitable polyacid. Suitable examples of polyacids include, but are not limited to, maleic acid; fumaric acid; itaconic acid; adipic acid; azelaic acid; succinic acid; sebacic acid; glutaric acid; decanoic diacid; dodecanoic diacid; phthalic acid; isophthalic acid; 5-tert-butylisophthalic acid; tetrachlorophthalic acid; tetrahydrophthalic acid; trimellitic acid; naphthalene dicarboxylic acid; naphthalene tetracarboxylic acid; terephthalic acid; hexahydrophthalic acid; methylhexahydrophthalic acid; dimethyl terephthalate; cyclohexane dicarboxylic acid; chlorendic anhydride; 1,3-cyclohexane dicarboxylic acid; 1,4-cyclohexane dicarboxylic acid; tricyclodecane polycarboxylic acid; endomethylene tetrahydrophthalic acid; endoethylene hexahydrophthalic acid; cyclohexanetetra carboxylic acid; cyclobutane tetracarboxylic; esters and anhydrides of all the aforementioned acids and combinations thereof.

“Polyol” and like terms, as used herein, refers to a compound having two or more hydroxyl groups, such as two, three or four hydroxyl groups. The hydroxyl groups of the polyol may be connected by a bridging group selected from: an alkylene group; an alkenylene group; an alkynylene group; or an arylene group. The polyol may be an organic polyol.

The polyester material may be formed from any suitable polyol. Suitable examples of polyols include, but are not limited to, alkylene glycols, such as ethylene glycol; propylene glycol; diethylene glycol; dipropylene glycol; triethylene glycol; tripropylene glycol; hexylene glycol; polyethylene glycol; polypropylene glycol and neopentyl glycol; hydrogenated bisphenol A; cyclohexanediol; propanediols including 1,2-propanediol; 1,3-propanediol; butyl ethyl propanediol; 2-methyl-1,3-propanediol; and 2-ethyl-2-butyl-1,3-propanediol; butanediols including 1,4-butanediol; 1,3-butanediol; and 2-ethyl-1,4-butanediol; pentanediols including trimethyl pentanediol and 2-methylpentanediol; cyclohexanedimethanol; hexanediols including 1,6-hexanediol; caprolactonediol (for example, the reaction product of epsilon-capro lactone and ethylene glycol); hydroxyalkylated bisphenols; polyether glycols, for example, poly(oxytetramethylene) glycol; trimethylol propane; pentaerythritol; di-pentaerythritol; trimethylol ethane; trimethylol butane; dimethylol cyclohexane; glycerol and the like or combinations thereof.

The polyester material may comprise polymers or copolymers formed from the reaction of diols and diacids; polyols or polyacid components may optionally be used to produce branched polymers.

The polyester material may be formed from a diacid. Suitable examples of diacids include, but are not limited to, phthalic acid; isophthalic acid; terephthalic acid; 1,4 cyclohexane dicarboxylic acid; succinic acid; adipic acid; azelaic acid; sebacic acid; fumaric acid; 2,6-naphthalene dicarboxylic acid; orthophthalic acid; phthalic anhydride; tetrahydrophthalic anhydride; maleic anhydride; succinic anhydride; itaconic anhydride; di-ester materials, such as dimethyl ester derivatives for example dimethyl isophthalate, dimethyl terephthalate, dimethyl 1,4-cyclohexane dicarboxylate, dimethyl 2,6-naphthalene di carboxylate, dimethyl fumarate, dimethyl orthophthalate, dimethylsuccinate, dimethyl glutarate, dimethyl adipate; esters and anhydrides of all the aforementioned acids; and mixtures thereof.

The polyester material may be formed from a diol. The polyester material may be formed from any suitable diol. Suitable examples of diols include, but are not limited to, ethylene glycol; 1,2-propane diol; 1,3-propane diol; 1,2-butandiol; 1,3-butandiol; 1,4-butandiol; but-2-ene 1,4-diol; 2,3-butane diol; 2-methyl 1,3-propane diol; 2,2′-dimethyl 1,3-propanediol (neopentyl glycol); 1,5 pentane diol; 3-methyl 1,5-pentanediol; 2,4-diethyl 1,5-pentane diol; 1,6-hexane diol; 2-ethyl 1,3-hexane diol; diethylene glycol; triethylene glycol; dipropylene glycol; tripropylene glycol; 2,2,4-trimethyl pentane 1,3-diol; 1,4 cyclohexane dimethanol; tricyclodecane dimethanol; 2,2,4,4-tetramethyl cyclobutane 1,3-diol; isosorbide; 1,4-cyclohexane diol; 1,1′-isopropylidene-bis(4-cyclohexanol); and mixtures thereof.

Examples of suitable additional polyacids which can optionally be used to produce branched polymers include, but are not limited to the following: trimellitic anhydride; trimellitic acid; pyromellitic acid; esters and anhydrides of all the aforementioned acids; and mixtures thereof.

Examples of suitable additional polyols which can optionally be used to produce branched polymers include, but are not limited to the following: glycerine; trimethylol propane; trimethylol ethane; 1,2,6 hexane triol; pentaerythritol; erythritol; di-trimethylol propane; di-pentaerythritol; N,N,N′,N′ tetra (hydroxyethyl) adipindiamide; N,N,N′N′ tetra (hydroxypropyl) adipindiamide; other, primarily hydroxyl, functional branching monomers; or mixtures thereof.

The polyester material may be formed from any suitable molar ratio of polyacid:polyol. The molar ratio of polyacid:polyol in the polyester material may be from 10:1 to 1:10, such as from 5:1 to 1:5, such as from 3:1 to 1:3, or even from 2:1 to 1:2. The molar ratio of polyacid:polyol in the polyester material may be from 1.5:1 to 1:1.5, such as 1.2:1 to 1:1.2.

The polyester material may be formed from any suitable molar ratio of diacid: diol. The molar ratio of diacid: diol in the polyester material may be from 10:1 to 1:10, such as from 5:1 to 1:5, such as from 3:1 to 1:3, or even from 2:1 to 1:2. The molar ratio of diacid: diol in the polyester material may be from 1.5:1 to 1:1.5, such as 1.2:1 to 1:1.2 or even from 1.1:1 to 1:1.1.

The polyester material may optionally be formed from any suitable molar ratio of diacid+diol to polyacid and/or polyol. The polyester material may comprise a molar ratio of diacid+diol to polyacid and/or polyol of from 100:1 to 1:1, such as from 100:1 to 5:1, such as from 100:1 to 20:1, or even from 100:1 to 50:1.

The polyester material may optionally be formed from additional monomers. The polyester material may optionally include an additional monomer selected from monoacids or monohydric alcohols or combinations thereof. The optional additional monomer may be organic.

The polyester material may optionally be formed from additional monoacids. “Monoacid”, and like terms as used herein, refers to compounds having one carboxylic acid group and includes an ester of the monoacid (where the acid group is esterified) or an anhydride. The monoacid may be an organic monoacid.

The polyester material may optionally be formed from any suitable additional monoacid. Suitable examples of monoacids include, but are not limited to, cyclohexane carboxylic acid; tricyclodecane carboxylic acid; camporic acid; benzoic acid; t-butyl benzoic acid; C₁-C₁₈ aliphatic carboxylic acids such as acetic acid; propanoic acid; butanoic acid; hexanoic acid; oleic acid; linoleic acid; undecanoic acid; lauric acid; isononanoic acid; fatty acids; hydrogenated fatty acids of naturally occurring oils; esters and/or anhydrides of any of the aforementioned acids and combinations thereof.

The polyester material may optionally be formed from additional monohydric alcohols. “Monohydric alcohol” and like terms as used herein, refers to compounds having one hydroxyl group. The monohydric alcohol may be an organic monohydric alcohol.

The polyester material may optionally be formed from any suitable additional monohydric alcohol. Suitable examples of monohydric alcohols include, but are not limited to, benzyl alcohol; hydroxyethoxybenzene; methanol; ethanol; propanol; butanol; pentanol; hexanol; heptanol; dodecyl alcohol; stearyl alcohol; oleyl alcohol; undecanol; cyclohexanol; phenol; phenyl carbinol; methylphenyl carbinol; cresol; monoethers of glycols; halogen-substituted or other substituted alcohols and combinations thereof.

The polyester material may be prepared in the presence of an esterification catalyst. The esterification catalyst may be chosen to promote the reaction of components by esterification and/or trans-esterification. Suitable examples of esterification catalysts for use in the preparation of the polyester material include, but are not limited to, metal compounds such as stannous octoate; stannous chloride; butyl stannoic acid (hydroxy butyl tin oxide); monobutyl tin tris(2-ethylhexanoate); chloro butyl tin dihydroxide; tetra-n-propyl titanate; tetra-n-butyl titanate; zinc acetate; acid compounds such as phosphoric acid; para-toluene sulphonic acid; dodecyl benzene sulphonic acid (DDBSA) and combinations thereof.

The esterification catalyst, when present, may be used in amounts from 0.001 to 1% by weight on total polymer components, such as from 0.01 to 0.2%, such as from 0.025 to 0.2% by weight on total polymer components.

The polyester material, when present, may be present in the UV curable undercoat coating composition in any suitable amount. The UV curable undercoat coating composition may comprise at least 1 wt %, such as at least 2 wt %, such as at least 5 wt %, such as at least 10 wt % polyester material based on the total solid weight of the UV curable undercoat coating composition. The UV curable undercoat coating composition may comprise up to 50 wt %, such as up to 40 wt %, such as up to 30 wt %, such as up to 25 wt %, such as up to 20 wt %, such as up to 15 wt % polyester material based on the total solid weight of the UV curable undercoat coating composition.

The UV curable undercoat coating composition may comprise from 1 to 50 wt %, such as from 2 to 50 wt %, such as from 5 to 50 wt %, such as from 10 to 50 wt % polyester material based on the total solid weight of the UV curable undercoat coating composition. The UV curable undercoat coating composition may comprise from 1 to 40 wt %, such as from 2 to 40 wt %, such as from 5 to 40 wt %, such as from 10 to 40 wt % polyester material based on the total solid weight of the UV curable undercoat coating composition. The UV curable undercoat coating composition may comprise from 1 to 30 wt %, such as from 2 to 30 wt %, such as from 5 to 30 wt %, such as from 10 to 30 wt % polyester material based on the total solid weight of the UV curable undercoat coating composition. The UV curable undercoat coating composition may comprise from 1 to 25 wt %, such as from 2 to 25 wt %, such as from 5 to 25 wt %, such as from 10 to 25 wt % polyester material based on the total solid weight of the UV curable undercoat coating composition. The UV curable undercoat coating composition may comprise from 1 to 20 wt %, such as from 2 to 20 wt %, such as from 5 to 20 wt %, such as from 10 to 20 wt % polyester material based on the total solid weight of the UV curable undercoat coating composition. The UV curable undercoat coating composition may comprise from 1 to 15 wt %, such as from 2 to 15 wt %, such as from 5 to 15 wt %, such as from 10 to 15 wt % polyester material based on the total solid weight of the UV curable undercoat coating composition.

The UV curable undercoat coating composition may comprise from 5 to 20 wt % polyester material based on the total solid weight of the UV curable undercoat coating composition.

The UV curable undercoat coating composition may comprise from 5 to 15 wt % polyester material based on the total solid weight of the UV curable undercoat coating composition.

The UV curable undercoat coating composition may comprise from 10 to 20 wt % polyester material based on the total solid weight of the UV curable undercoat coating composition.

The UV curable undercoat coating composition may comprise from 10 to 15 wt % polyester material based on the total solid weight of the UV curable undercoat coating composition.

### UV Curable Overcoat Coating Composition

The multi-layer coating system may comprise an overcoat coating layer derived from a UV curable overcoat coating composition comprising an epoxy material, a polyol material and/or a diketone-functional material, and a photoinitiator. The terms “UV curable overcoat coating composition” and “overcoat coating composition” may be used interchangeably herein. Any reference to “overcoat coating composition” should be construed as said overcoat coating composition being UV curable, unless specified otherwise.

The UV curable overcoat coating composition comprises an epoxy material. Suitable epoxy materials are as defined herein in relation to the UV curable undercoat coating composition.

The epoxy material may be present in any suitable amount. The UV curable overcoat coating composition may comprise at least 20 wt %, such as at least 30 wt %, such as at least 40 wt %, such as at least 50 wt %, such as at least 55 wt %, such as at least 60 wt %, such as at least 65 wt % epoxy material based on the total solid weight of the UV curable overcoat coating composition. The UV curable overcoat coating composition may comprise up to 99 wt %, such as up to 95 wt %, such as up to 90 wt %, such as up to 85 wt %, such as up to 80 wt %, such as up to 75 wt % epoxy material based on the total solid weight of the UV curable overcoat coating composition.

The UV curable overcoat coating composition may comprise from 20 to 99 wt %, such as from 30 to 99 wt %, such as from 40 to 99 wt %, such as from 50 to 99 wt %, such as from 55 to 99 wt %, such as from 60 to 99 wt %, such as from 65 to 99 wt % epoxy material based on the total solid weight of the UV curable overcoat coating composition. The UV curable overcoat coating composition may comprise from 20 to 95 wt %, such as from 30 to 95 wt %, such as from 40 to 95 wt %, such as from 50 to 95 wt %, such as from 55 to 95 wt %, such as from 60 to 95 wt %, such as from 65 to 95 wt % epoxy material based on the total solid weight of the UV curable overcoat coating composition. The UV curable overcoat coating composition may comprise from 20 to 90 wt %, such as from 30 to 90 wt %, such as from 40 to 90 wt %, such as from 50 to 90 wt %, such as from 55 to 90 wt %, such as from 60 to 90 wt %, such as from 65 to 90 wt % epoxy material based on the total solid weight of the UV curable overcoat coating composition. The UV curable overcoat coating composition may comprise from 20 to 85 wt %, such as from 30 to 85 wt %, such as from 40 to 85 wt %, such as from 50 to 85 wt %, such as from 55 to 85 wt %, such as from 60 to 85 wt %, such as from 65 to 85 wt % epoxy material based on the total solid weight of the UV curable overcoat coating composition. The UV curable overcoat coating composition may comprise from 20 to 80 wt %, such as from 30 to 80 wt %, such as from 40 to 80 wt %, such as from 50 to 80 wt %, such as from 55 to 80 wt %, such as from 60 to 80 wt %, such as from 65 to 80 wt % epoxy material based on the total solid weight of the UV curable overcoat coating composition. The UV curable overcoat coating composition may comprise from 20 to 75 wt %, such as from 30 to 75 wt %, such as from 40 to 75 wt %, such as from 50 to 75 wt %, such as from 55 to 75 wt %, such as from 60 to 75 wt %, such as from 65 to 75 wt % epoxy material based on the total solid weight of the UV curable overcoat coating composition.

The UV curable overcoat coating composition may comprise from 50 to 90 wt % epoxy material based on the total solid weight of the UV curable overcoat coating composition.

The UV curable overcoat coating composition may comprise from 55 to 85 wt % epoxy material based on the total solid weight of the UV curable overcoat coating composition.

The UV curable overcoat coating composition may comprise from 60 to 80 wt % epoxy material based on the total solid weight of the UV curable overcoat coating composition.

The UV curable overcoat coating composition may comprise from 65 to 75 wt % epoxy material based on the total solid weight of the UV curable overcoat coating composition.

The UV curable overcoat coating composition may comprise a polyol material. The polyol material may be any suitable polyol material. For example, the polyol material of the UV curable overcoat coating composition may comprise a hydroxy-functional polyester resin, a polycaprolactone, a polypropylene glycol, a fatty acid-modified dendritic polymer having two or more terminal hydroxy groups, such as 2 to 6 terminal hydroxy groups, such as 4 to 6 terminal hydroxy groups, such as 6 terminal hydroxy groups, and/or a hydroxy-functional vinyl resin. Examples of suitable hydroxy-functional polyester resins, polycaprolactones, polypropylene glycols, fatty acid-modified dendritic polymers and hydroxy-functional vinyl resins are as defined herein in relation to the UV curable undercoat coating composition.

The polyol material of the UV curable overcoat coating composition may comprise a commercially available polyol material and/or a commercially available hydroxy-functional polyester resin. Examples of suitable commercially available polyol materials and hydroxy-functional polyester resins are as defined herein in relation to the UV curable undercoat coating composition.

The polyol material of the UV curable overcoat coating composition may have a hydroxyl value of at least 25 mg KOH/g.

The polyol material of the UV curable overcoat coating composition may have an OHV of at least 30 mg KOH/g, such as at least 40 mg KOH/g, such as at least 50 mg KOH/g, such as at least 60 mg KOH/g, such as at least 70 mg KOH/g, such as at least 80 mg KOH/g, such as at least 90 mg KOH/g, such as at least mg 100 mg KOH/g, such as at least 110 mg KOH/g, such as at least 120 mg KOH/g, such as at least 130 mg KOH/g, such as at least 140 mg KOH/g, such as at least 150 mg KOH/g, such as at least 200 mg KOH/g, such as at least 250 mg KOH/g. The polyol material of the UV curable overcoat coating composition may have an OHV of up to 650 mg KOH/g, such as up to 600 mg KOH/g, such as up to 550 mg KOH/g, such as up to 500 mg KOH/g, such as up to 450 mg KOH/g, such as up to 400 mg KOH/g.

The polyol material of the UV curable overcoat coating composition may have any suitable acid value (AV; also known as acid number or AN). The polyol material of the UV curable overcoat coating composition may have an acid value up to 50 mg KOH/g, such as up to 30 mg KOH/g, such as up to 20 mg KOH/g, such as up to 10 mg KOH/g, such as up to 5 mg KOH/g, such as up to 4 mg KOH/g, such as up to 3 mg KOH/g, such as up to 2 mg KOH/g, such as up to 1 mg KOH/g.

The polyol material of the UV curable overcoat coating composition may have any suitable number-average molecular weight (Mn). The polyol material of the UV curable overcoat coating composition may have an Mn of at least 100 Daltons (Da=g/mole), such as at least 200 Da, such as at least 250 Da, such as at least 300 Da. The polyol material of the UV curable overcoat coating composition may have an Mn up to 50,000 Da, such as up to 25,000 Da, such as up to 20,000 Da, such as up to 10,000 Da, such as up to 5,000 Da, such as up to 4,500 Da, such as up to 4,000 Da, such as up to 3,500 Da.

The polyol material of the UV curable overcoat coating composition may be a low molecular weight polyol material.

The polyol material of the UV curable overcoat coating composition may have any suitable weight-average molecular weight (Mw). The polyol material of the UV curable overcoat coating composition may have an Mw of at least 100 Daltons (Da=g/mole), such as at least 200 Da, such as at least 250 Da, such as at least 300 Da. The polyol material of the UV curable overcoat coating composition may have an Mw up to 50,000 Da, such as up to 25,000 Da, such as up to 20,000 Da, such as up to 10,000 Da, such as up to 5,000 Da, such as up to 4,500 Da, such as up to 4,000 Da, such as up to 3,500 Da.

The UV curable overcoat coating composition may comprise a diketone-functional material. The diketone-functional material may be any suitable diketone-functional material. Examples of suitable diketone-functional materials are as defined herein in relation to the UV curable undercoat coating composition.

The UV curable overcoat coating composition comprises a polyol material and/or a diketone functional material. The UV curable overcoat coating composition may comprise a polyol material. The UV curable overcoat coating composition may comprise any suitable amount of polyol material. The UV curable overcoat coating composition may comprise at least 2 wt % polyol material based on the total solid weight of the composition.

The UV curable overcoat coating composition may comprise at least 3 wt %, such as at least 4 wt %, such as at least 5 wt % polyol material based on the total solid weight of the composition. The UV curable overcoat coating composition may comprise up to 80 wt %, such as up to 70 wt %, such as up to 60 wt %, such as up to 50 wt %, such as up to 40 wt %, such as up to 30 wt %, such as up to 20 wt %, such as up to 15 wt % polyol material based on the total solid weight of the composition.

The UV curable overcoat coating composition may comprise from 2 to 80 wt %, such as from 2 to 70 wt %, such as from 2 to 60 wt %, such as from 2 to 50 wt %, such as from 2 to 40 wt %, such as from 2 to 30 wt %, such as from 2 to 20 wt %, such as from 2 to 15 wt % polyol material based on the total solid weight of the composition. The UV curable overcoat coating composition may comprise from 3 to 80 wt %, such as from 3 to 70 wt %, such as from 3 to 60 wt %, such as from 3 to 50 wt %, such as from 3 to 40 wt %, such as from 3 to 30 wt %, such as from 3 to 20 wt %, such as from 3 to 15 wt % polyol material based on the total solid weight of the composition. The UV curable overcoat coating composition may comprise from 4 to 80 wt %, such as from 4 to 70 wt %, such as from 4 to 60 wt %, such as from 4 to 50 wt %, such as from 4 to 40 wt %, such as from 4 to 30 wt %, such as from 4 to 20 wt %, such as from 4 to 15 wt % polyol material based on the total solid weight of the composition. The UV curable overcoat coating composition may comprise from 5 to 80 wt %, such as from 5 to 70 wt %, such as from 5 to 60 wt %, such as from 5 to 50 wt %, such as from 5 to 40 wt %, such as from 5 to 30 wt %, such as from 5 to 20 wt %, such as from 5 to 15 wt % polyol material based on the total solid weight of the composition.

The UV curable overcoat coating composition may comprise at least 5 wt % polyol material based on the total solid weight of the composition.

The UV curable overcoat coating composition may comprise from 5 to 30 wt % polyol material based on the total solid weight of the composition.

The UV curable overcoat coating composition may comprise from 5 to 20 wt % polyol material based on the total solid weight of the composition.

The UV curable overcoat coating composition may comprise from 5 to 15 wt % polyol material based on the total solid weight of the composition.

The UV curable overcoat coating composition may comprise a diketone-functional material. The UV curable overcoat coating composition may comprise any suitable amount of diketone-functional material. The UV curable overcoat coating composition may comprise at least 2 wt % diketone-functional material based on the total solid weight of the composition. The UV curable overcoat coating composition may comprise at least 3 wt %, such as at least 4 wt %, such as at least 5 wt % diketone-functional material based on the total solid weight of the composition. The UV curable overcoat coating composition may comprise up to 80 wt %, such as up to 70 wt %, such as up to 60 wt %, such as up to 50 wt %, such as up to 40 wt %, such as up to 30 wt %, such as up to 20 wt %, such as up to 15 wt % diketone-functional material based on the total solid weight of the composition.

The UV curable overcoat coating composition may comprise from 2 to 80 wt %, such as from 2 to 70 wt %, such as from 2 to 60 wt %, such as from 2 to 50 wt %, such as from 2 to 40 wt %, such as from 2 to 30 wt %, such as from 2 to 20 wt %, such as from 2 to 15 wt % diketone-functional material based on the total solid weight of the composition. The UV curable overcoat coating composition may comprise from 3 to 80 wt %, such as from 3 to 70 wt %, such as from 3 to 60 wt %, such as from 3 to 50 wt %, such as from 3 to 40 wt %, such as from 3 to 30 wt %, such as from 3 to 20 wt %, such as from 3 to 15 wt % diketone-functional material based on the total solid weight of the composition. The UV curable overcoat coating composition may comprise from 4 to 80 wt %, such as from 4 to 70 wt %, such as from 4 to 60 wt %, such as from 4 to 50 wt %, such as from 4 to 40 wt %, such as from 4 to 30 wt %, such as from 4 to 20 wt %, such as from 4 to 15 wt % diketone-functional material based on the total solid weight of the composition. The UV curable overcoat coating composition may comprise from 5 to 80 wt %, such as from 5 to 70 wt %, such as from 5 to 60 wt %, such as from 5 to 50 wt %, such as from 5 to 40 wt %, such as from 5 to 30 wt %, such as from 5 to 20 wt %, such as from 5 to 15 wt % diketone-functional material based on the total solid weight of the composition.

The UV curable overcoat coating composition may comprise at least 5 wt % diketone-functional material based on the total solid weight of the composition.

The UV curable overcoat coating composition may comprise from 5 to 30 wt % diketone-functional material based on the total solid weight of the composition.

The UV curable overcoat coating composition may comprise from 5 to 20 wt % diketone-functional material based on the total solid weight of the composition.

The UV curable overcoat coating composition may comprise from 5 to 15 wt % diketone-functional material based on the total solid weight of the composition.

The UV curable overcoat coating composition may not comprise a diketone-functional material. For example, the UV curable overcoat coating composition may comprise less than 1 wt %, such as less than 0.5 wt %, such as less than 0.1 wt %, such as less than 0.05 wt %, such as substantially 0 wt % diketone-functional material based on the total solid weight of the composition.

The UV curable overcoat coating composition comprises a photoinitiator. The photoinitiator may be formed from any suitable photoinitiator. Examples of suitable photoinitiators are as defined herein in relation to the UV curable undercoat coating composition.

The photoinitiator may be present in the UV curable overcoat coating composition in any suitable amount. The UV curable overcoat coating composition may comprise at least 0.1 wt %, such as at least 0.5 wt %, such as at least 1 wt %, such as at least 2 wt %, such as at least 3 wt % photoinitiator based on the total solid weight of the composition. The UV curable overcoat coating composition may comprise up to 50 wt %, such as up to 40 wt %, such as up to 30 wt %, such as up to 25 wt %, such as up to 20 wt %, such as up to 15 wt %, such as up to 10 wt % photoinitiator based on the total solid weight of the composition.

The UV curable overcoat coating composition may comprise from 0.1 to 50 wt %, such as from 0.5 to 50 wt %, such as from 1 to 50 wt %, such as from 2 to 50 wt %, such as from 3 to 50 wt % photoinitiator based on the total solid weight of the composition. The UV curable overcoat coating composition may comprise from 0.1 to 40 wt %, such as from 0.5 to 40 wt %, such as from 1 to 40 wt %, such as from 2 to 40 wt %, such as from 3 to 40 wt % photoinitiator based on the total solid weight of the composition. The UV curable overcoat coating composition may comprise from 0.1 to 30 wt %, such as from 0.5 to 30 wt %, such as from 1 to 30 wt %, such as from 2 to 30 wt %, such as from 3 to 30 wt % photoinitiator based on the total solid weight of the composition. The UV curable overcoat coating composition may comprise from 0.1 to 25 wt %, such as from 0.5 to 25 wt %, such as from 1 to 25 wt %, such as from 2 to 25 wt %, such as from 3 to 25 wt % photoinitiator based on the total solid weight of the composition. The UV curable overcoat coating composition may comprise from 0.1 to 20 wt %, such as from 0.5 to 20 wt %, such as from 1 to 20 wt %, such as from 2 to 20 wt %, such as from 3 to 20 wt % photoinitiator based on the total solid weight of the composition. The UV curable overcoat coating composition may comprise from 0.1 to 15 wt %, such as from 0.5 to 15 wt %, such as from 1 to 15 wt %, such as from 2 to 15 wt %, such as from 3 to 15 wt % photoinitiator based on the total solid weight of the composition. The UV curable overcoat coating composition may comprise from 0.1 to 10 wt %, such as from 0.5 to 10 wt %, such as from 1 to 10 wt %, such as from 2 to 10 wt %, such as from 3 to 10 wt % photoinitiator based on the total solid weight of the composition.

The UV curable overcoat coating composition may comprise from 1 to 10 wt % photoinitiator based on the total solid weight of the composition.

The UV curable overcoat coating composition may comprise from 2 to 8 wt % photoinitiator based on the total solid weight of the composition.

The UV curable overcoat coating composition may further comprise a wax. As used herein, “wax” means a hydrophobic, malleable solid near ambient temperatures that shows lower viscosity in the melt phase.

The wax may comprise a micronized wax and a micronized polysaccharide. As used herein, the term “micronized” takes its usual meaning of particles having D50 values in the micrometer range. For example, the micronized particles may have D50 values of up to 100 μm, such as up to 50 μm, such as up to 30 μm, or up to 10 μm. Micronization may be achieved by any suitable means, which would be well known to persons skilled in the art, including by mechanical means such as milling and grinding. The D50 value may be measured by any suitable method. Methods to measure D50 values will be well known to a person skilled in the art. The D50 values reported herein were measured using a Malvern Mastersizer 2000 laser diffraction testing instrument, as would be well known to persons skilled in the art.

The micronized wax may comprise any suitable wax, such as a polyolefin wax, a Fischer-Tropsch wax, a polyamide wax, carnauba wax, and/or paraffin wax.

The micronized wax may comprise a polyolefin wax, such as polyethylene wax and/or polypropylene wax.

The micronized polysaccharide may be in the form of a wax, or may not be a wax. The micronized polysaccharide may comprise a polysaccharide wax. When the micronized polysaccharide comprises a polysaccharide wax, the UV curable overcoat coating composition may comprise an additional micronized wax that does not comprise a polysaccharide. In other words, when the micronized polysaccharide comprises a micronized polysaccharide wax, the UV curable overcoat coating composition may further comprise an additional micronized wax, such as a polyolefin wax, a Fischer-Tropsch wax, a polyamide wax, carnauba wax, and/or paraffin wax (for example a polyolefin wax) as described herein.

The micronized polysaccharide may comprise any suitable micronized polysaccharide, such as a polysaccharide comprising glucose units (such as glucose monomers linked by a glycosidic bonds). The micronized polysaccharide may comprise starch, glycogen, cellulose, cellulose, chitosan, chitin, amylose and/or sugar-cane (such as starch, glycogen, cellulose, cellulose, chitosan, chitin and/or amylose).

The weight ratio of the micronized wax to the micronized polysaccharide may be at least 95:5, such as at least 90:10. The weight ratio of the micronized wax to the micronized polysaccharide may be up to 5:95, such as up to 80:20. The weight ratio of the micronized wax to the micronized polysaccharide may be from 95:5 to 5:95, such as from 90:10 to 80:20.

The micronized wax and micronized polysaccharide may be included in the UV curable overcoat coating composition as separate components or as an additive composition that comprises the micronized wax and micronized polysaccharide (for example wherein the micronized wax and micronized polysaccharide are pre-mixed to form the additive composition). The additive composition may comprise the micronized wax and micronized polysaccharide, such as wherein the wax and polysaccharide is processed and/or micronized prior to use to provide the desired particles sizes.

The UV curable overcoat coating composition may comprise any suitable amount of wax. The UV curable overcoat coating composition may comprise at least 0.01 wt %, such as at least 0.05 wt %, such as at least 0.1 wt %, such as at least 0.2 wt %, such as at least 0.3 wt %, such as at least 0.4 wt %, such as at least 0.5 wt % wax based on the total solid weight of the composition. The UV curable overcoat coating composition may comprise up to 5 wt %, such as up to 4 wt %, such as up to 3 wt %, such as up to 2 wt %, such as up to 1 wt % wax based on the total solid weight of the composition.

The UV curable overcoat coating composition may comprise from 0.01 to 5 wt %, such as from 0.05 to 5 wt %, such as from 0.1 to 5 wt %, such as from 0.2 to 5 wt %, such as from 0.3 to 5 wt %, such as from 0.4 to 5 wt %, such as from 0.5 to 5 wt % wax based on the total solid weight of the composition. The UV curable overcoat coating composition may comprise from 0.01 to 4 wt %, such as from 0.05 to 4 wt %, such as from 0.1 to 4 wt %, such as from 0.2 to 4 wt %, such as from 0.3 to 4 wt %, such as from 0.4 to 4 wt %, such as from 0.5 to 4 wt % wax based on the total solid weight of the composition. The UV curable overcoat coating composition may comprise from 0.01 to 3 wt %, such as from 0.05 to 3 wt %, such as from 0.1 to 3 wt %, such as from 0.2 to 3 wt %, such as from 0.3 to 3 wt %, such as from 0.4 to 3 wt %, such as from 0.5 to 3 wt % wax based on the total solid weight of the composition. The UV curable overcoat coating composition may comprise from 0.01 to 2 wt %, such as from 0.05 to 2 wt %, such as from 0.1 to 2 wt %, such as from 0.2 to 2 wt %, such as from 0.3 to 2 wt %, such as from 0.4 to 2 wt %, such as from 0.5 to 2 wt % wax based on the total solid weight of the composition. The UV curable overcoat coating composition may comprise from 0.01 to 1 wt %, such as from 0.05 to 1 wt %, such as from 0.1 to 1 wt %, such as from 0.2 to 1 wt %, such as from 0.3 to 1 wt %, such as from 0.4 to 1 wt %, such as from 0.5 to 1 wt % wax based on the total solid weight of the composition.

The UV curable overcoat coating composition may comprise an (meth)acrylate-functional material. By “(meth)acrylate-functional”, and like terms as used herein, is meant a material, typically a resin, that comprises (meth)acrylate functionality as an end group or a side chain thereof. The (meth)acrylate functionality suitably provides the material with reactive functionality, such as ethylenic unsaturation, that is able to participate in crosslinking reactions during cure. The UV curable overcoat coating composition may comprise any suitable (meth)acrylate-functional material. The (meth)acrylate-functional material may comprise a (meth)acrylate-functional resin. Examples of suitable (meth)acrylate-functional materials include, but are not limited to, (meth)acrylate-functional polyesters, (meth)acrylate-functional polyurethanes, (meth)acrylate-functional epoxy materials, and combinations thereof.

The (meth)acrylate-functional material may comprise a commercially available material. Examples of suitable commercially available (meth)acrylate-functional materials include, but are not limited to, those sold under the trade name Miramer (commercially available from Miwon Speciality Chemical Co.), such as Miramer S5242, Miramer PS6300, Miramer PS460, Miramer P2229, Miramer PU610, Miramer SC2100, Miramer ME2500, and Miramer PE2130; those sold under the trade name Sartomer (commercially available from Arkema), such as Sartomer CN704, Sartomer 790, Sartomer CN965, and Sartomer CN981; those sold under the trade name Laromer (commercially available from BASF) such as Laromer LR 8863 and Laromer UP 9118; those sold under the trade name Ebecryl (commercially available from Allnex) such as Ebecryl 416, Ebecryl 895, Ebecryl 1885, Ebecryl 4690, Ebecryl 8894 and Ebecryl PEG200DMA; and combinations thereof.

The UV curable overcoat coating composition may comprise any suitable amount of (meth)acrylate-functional material. The UV curable overcoat coating composition may comprise at least 1 wt %, such as at least 2 wt %, such as at least 3 wt %, such as at least 4 wt %, such as at least 5 wt %, such as at least 6 wt %, such as at least 7 wt %, such as at least 8 wt %, such as at least 9 wt %, such as at least 10 wt % (meth)acrylate-functional material based on the total solid weight of the composition. The UV curable overcoat coating composition may comprise up to 50 wt %, such as up to 40 wt %, such as up to 30 wt %, such as up to 20 wt %, or even up to 15 wt % (meth)acrylate-functional material based on the total solid weight of the composition.

The UV curable overcoat coating composition may comprise from 1 to 50 wt %, such as from 2 to 50 wt %, such as from 3 to 50 wt %, such as from 4 to 50 wt %, such as from 5 to 50 wt %, such as from 6 to 50 wt %, such as from 7 to 50 wt %, such as from 8 to 50 wt %, such as from 9 to 50 wt %, such as from 10 to 50 wt % (meth)acrylate-functional material based on the total solid weight of the composition. The UV curable overcoat coating composition may comprise from 1 to 40 wt %, such as from 2 to 40 wt %, such as from 3 to 40 wt %, such as from 4 to 40 wt %, such as from 5 to 40 wt %, such as from 6 to 40 wt %, such as from 7 to 40 wt %, such as from 8 to 40 wt %, such as from 9 to 40 wt %, such as from 10 to 40 wt % (meth)acrylate-functional material based on the total solid weight of the composition. The UV curable overcoat coating composition may comprise from 1 to 30 wt %, such as from 2 to 30 wt %, such as from 3 to 30 wt %, such as from 4 to 30 wt %, such as from 5 to 30 wt %, such as from 6 to 30 wt %, such as from 7 to 30 wt %, such as from 8 to 30 wt %, such as from 9 to 30 wt %, such as from 10 to 30 wt % (meth)acrylate-functional material based on the total solid weight of the composition. The UV curable overcoat coating composition may comprise from 1 to 20 wt %, such as from 2 to 20 wt %, such as from 3 to 20 wt %, such as from 4 to 20 wt %, such as from 5 to 20 wt %, such as from 6 to 20 wt %, such as from 7 to 20 wt %, such as from 8 to 20 wt %, such as from 9 to 20 wt %, such as from 10 to 20 wt % (meth)acrylate-functional material based on the total solid weight of the composition. The UV curable overcoat coating composition may comprise from 1 to 15 wt %, such as from 2 to 15 wt %, such as from 3 to 15 wt %, such as from 4 to 15 wt %, such as from 5 to 15 wt %, such as from 6 to 15 wt %, such as from 7 to 15 wt %, such as from 8 to 15 wt %, such as from 9 to 15 wt %, such as from 10 to 15 wt % (meth)acrylate-functional material based on the total solid weight of the composition.

The UV curable overcoat coating composition may comprise from 8 to 20 wt %, such as from 9 to 20 wt %, such as from 10 to 15 wt % (meth)acrylate-functional material based on the total solid weight of the composition.

The UV curable overcoat coating composition may comprise a free-radical photoinitiator. For example, the UV curable overcoat coating composition may comprise an (meth)acrylate-functional material and a free-radical photoinitiator.

Examples of suitable free-radical initiators include, but are not limited to, oxy-phenyl-acetic acid 2-[2-oxo-2-phenyl-acetoxy-ethoxy]-ethyl ester; oxy-phenyl-acetic acid 2-[2-hydroxy-ethoxy]-ethyl ester; tertiary butyl perbenzoate; tert butyl peroxy 3,5,5 trimethylhexanoate; tertiary butyl peroxy 2-ethyl hexanoate; T-amyl peroxy 2-ethyl hexanoate; di tertiary butyl peroxide; tertiary butyl peracetate; tertiary butyl peroctoate; azo type initiators such as, for example, 2,2′-azobis(isobutyronitrile), 2,2′-Azobis(2-methylbutyronitrile), 2,2′-Azobis(2.4-dimethyl valeronitrile) and 2,2′-Azobis(4-methoxy-2.4-dimethyl valeronitrile); persulphate initiators such as, for example, ammonium persulphate, sodium persulphate or potassium persulphate; and combinations thereof.

The free-radical initiator may comprise oxy-phenyl-acetic acid 2-[2-oxo-2-phenyl-acetoxy-ethoxy]-ethyl ester and/or oxy-phenyl-acetic acid 2-[2-hydroxy-ethoxy]-ethyl ester, such as oxy-phenyl-acetic acid 2-[2-oxo-2-phenyl-acetoxy-ethoxy]-ethyl ester and oxy-phenyl-acetic acid 2-[2-hydroxy-ethoxy]-ethyl ester.

Examples of suitable commercially available free-radical photoinitiators include, but are not limited to, those sold under the trade name Omnirad (commercially available from IGM Resins), such as Omnirad 754, Omnirad 1173, Omnirad 184 and Omnirad TPO; those sold under the trade name Genocure (commercially available from Rahn Group) such as Genocure TPO, Genocure MBF and Genocure LBC.

The free-radical photoinitiator may be present in the UV curable overcoat coating composition in any suitable amount. The UV curable overcoat coating composition may comprise at least 0.1 wt %, such as at least 0.5 wt %, such as at least 1 wt % free-radical photoinitiator based on the total solid weight of the composition. The UV curable overcoat coating composition may comprise up to 5 wt %, such as up to 4 wt %, such as up to 3 wt %, such as up to 2 wt %, such as up to 1 wt % free-radical photoinitiator based on the total solid weight of the composition.

### Further Coating Ingredients

The UV curable undercoat coating composition and/or the UV curable overcoat coating composition may comprise a further resin material. Suitable further resin materials will be well known to a person skilled in the art. Examples of suitable further resin materials include, but are not limited to, acrylic resins; polyvinyl chloride (PVC) resins; alkyd resins; polyurethane resins; polysiloxane resins; or combinations thereof.

The UV curable undercoat coating composition and/or the UV curable overcoat coating composition may comprise other optional materials well known in the art of formulating coatings, such as colorants, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, catalysts, grind vehicles, lubricants, waxes and other customary auxiliaries.

As used herein, the term “colorant” means any substance that imparts colour and/or other opacity and/or other visual effect to the composition. The colorant can be added to the coating composition in any suitable form, such as discrete particles, dispersions, solutions and/or flakes. A single colorant or a mixture of two or more colorants can be used in the coating compositions. Suitable colorants are listed in U.S. Pat. No. 8,614,286, column 7, line 2 through column 8, line 65, which is incorporated by reference herein. Examples for packaging coating compositions are those approved for food contact, such as titanium dioxide; iron oxides, such as black iron oxide; aluminium paste; aluminium powder such as aluminium flake; carbon black; ultramarine blue; phthalocyanines, such as phthalocyanine blue and phthalocyanine green; chromium oxides, such as chromium green oxide; graphite fibrils; ferried yellow; quindo red; and combinations thereof, and those listed in Article 178.3297 of the Code of Federal Regulations, which is incorporated by reference herein.

When it is desired to cure the composition with ultraviolet light, the colorant utilized is typically an ultraviolet light transparent pigment. The phrase “ultraviolet light transparent” is used to mean that the pigment does not substantially interfere with UV curing of the composition. Examples of ultraviolet light transparent pigments include, but are not limited to, talc, calcium carbonate, aluminum silicate, magnesium silicate, barytes and silica (SiO₂). Colorants generally employed to impart colour in non-UV cured coating compositions typically absorb or block ultraviolet light thereby interfering with UV curing of the composition. Accordingly, where some degree of colour tinting of the composition is desired, such conventional colouring pigments typically are employed in only limited amounts when cure is to be effected utilizing UV.

The colorant, when present, may be used in the UV curable undercoat coating composition and/or the UV curable overcoat coating composition in any suitable amount. The colorant, when present, may be used in the UV curable undercoat coating composition and/or the UV curable overcoat coating composition in amounts up to 90 wt %, such as up to 50 wt %, or even up to 10 wt % based on the total solid weight of the composition.

Suitable reactive diluents will be known to the person skilled in the art. Examples of suitable commercially available reactive diluents include but are not limited to those sold under the tradename D.E.R.® commercially available from Olin Epoxy, such as D.E.R. 731; those sold under the trade name Curalite (commercially available from Perstorp) such as Curalite OX; those sold under the trade name Uvi-Cure (commercially available from Arkema) such as Uvi-Cure S170, S160, S130 and S140.

The reactive diluent, when present, may comprise an oxetane group. The reactive diluent may comprise one or more oxetane group(s). For example, the oxetane group-containing reactive diluent may be in the form of a monomer, dimer, oligomer, etc. The oxetane group may be substituted or unsubstituted. For example, the oxetane group may be substituted with an alkyl, alkenyl, alkynyl or aryl group, such as an alkyl group, such as a C1-C10 alkyl group, such as a C1-C6 alkyl group, such as a C1-C4 alkyl group, such as methyl or ethyl, such as ethyl. The oxetane group may be additionally or alternatively be substituted with a hydroxyl group, such as a group of formula —(X)ₙ—OH group, wherein X is an organic bridging group, such as a C1-C10 alkylene group, such as a C1-C6 alkylene group, such as a C1-C4 alkylene group, such as methylene or ethylene, such as methylene, and n is 0 or 1, such as 1.

Examples of suitable commercially available oxetane group-containing reactive diluents include, but are not limited to, those sold under the trade name Curalite (commercially available from Perstorp) such as Curalite OX, those sold under the trade name Uvi-Cure (commercially available from Arkema) such as Uvi-Cure S170, S160, S130 and S140.

The reactive diluent may be present in any suitable amount. The UV curable undercoat coating composition and/or UV curable overcoat coating composition may comprise at least 1 wt %, such as at least 2 wt %, such as at least 3 wt %, such as at least 4 wt %, such as at least 5 wt % reactive diluent based on the total solid weight of the composition. The UV curable undercoat coating composition and/or UV curable overcoat coating composition may comprise up to 50 wt %, such as up to 40 wt %, such as up to 30 wt %, such as up to 25 wt %, such as up to 20 wt % reactive diluent based on the total solid weight of the composition.

The UV curable undercoat coating composition and/or UV curable overcoat coating composition may comprise from 5 to 50 wt %, such as from 5 to 40 wt %, such as from 5 to 30 wt %, such as from 5 to 25 wt %, such as from 5 to 20 wt % reactive diluent based on the total solid weight of the composition. The UV curable undercoat coating composition and/or UV curable overcoat coating composition may comprise from 4 to 50 wt %, such as from 4 to 40 wt %, such as from 4 to 30 wt %, such as from 4 to 25 wt %, such as from 4 to 20 wt % reactive diluent based on the total solid weight of the composition. The UV curable undercoat coating composition and/or UV curable overcoat coating composition may comprise from 3 to 50 wt %, such as from 3 to 40 wt %, such as from 3 to 30 wt %, such as from 3 to 25 wt %, such as from 3 to 20 wt % reactive diluent based on the total solid weight of the composition. The UV curable undercoat coating composition and/or UV curable overcoat coating composition may comprise from 2 to 50 wt %, such as from 2 to 40 wt %, such as from 2 to 30 wt %, such as from 2 to 25 wt %, such as from 2 to 20 wt % reactive diluent based on the total solid weight of the composition. The UV curable undercoat coating composition and/or UV curable overcoat coating composition may comprise from 1 to 50 wt %, such as from 1 to 40 wt %, such as from 1 to 30 wt %, such as from 1 to 25 wt %, such as from 5 to 20 wt % reactive diluent based on the total solid weight of the composition.

The UV curable undercoat coating composition and/or UV curable overcoat coating composition may comprise from 5 to 20 wt % reactive diluent based on the total solid weight of the composition.

Suitable lubricants will be known to the person skilled in the art. Examples of suitable lubricants include, but are not limited to, lanolin wax, polytetrafluoroethylene (PTFE) wax, such as Lanco TF 1780 commercially available from Lubrizol, carnauba wax, polyethylene type lubricants such as polyethylene wax, for example, Lanco SF 1500, commercially available from Lubrizol, micro crystalline wax, such as Lubaprint 121/F commercially available from Munzing, Ceracol 615 commercially available from BYK; and combinations thereof. The lubricant, when present, may be used in the UV curable undercoat coating composition and/or the UV curable overcoat coating composition in amounts of at least 0.01 wt % based on the total solid weight of the composition.

The UV curable undercoat coating composition, UV curable overcoat coating composition and/or multi-layer coating system may be substantially free, may be essentially free or may be completely free of polytetrafluoroethylene (PTFE). By “substantially free” we mean to refer to coating compositions, coating systems, or components thereof, containing less than 1000 parts per million (ppm) of PTFE. By “essentially free” we mean to refer to coating compositions, coating systems, or components thereof, containing less than 100 ppm of PTFE. By “completely free” we mean to refer to coating compositions, coating systems, or components thereof, containing less than 20 parts per billion (ppb) of PTFE. The UV curable overcoat coating composition and/or coating system may comprise 0 wt % of PTFE.

Surfactants may optionally be added to the UV curable undercoat coating composition and/or the UV curable overcoat coating composition in order to aid in flow and wetting of the substrate. Suitable surfactants will be known to the person skilled in the art. The surfactant, when present, may be chosen to be compatible with food and/or beverage packaging applications. Examples of suitable surfactants include, but are not limited to, alkyl sulphates (e.g., sodium lauryl sulphate); ether sulphates; phosphate esters; sulphonates; and their various alkali, ammonium, amine salts; aliphatic alcohol ethoxylates; alkyl phenol ethoxylates (e.g. nonyl phenol polyether); salts; polyether siloxane copolymers, such as those sold under the tradename Tego Glide®, for example Tego Glide B 1484 commercially available from Evonik; polysiloxanes such as those sold under the tradename Borchi®, for example Borchi Gol 1376 commercially available from Borchers, those sold under the tradename BYK®, for example BYK 313 and BYK 370 commercially available from BYK Chemie and those sold under the tradename Tego Glide®, for example Tego Glide 496 commercially available from Evonik; polyvinyl polymers, such as those sold under the tradename Dynoadd®, for example Dynoadd F300 commercially available from Dynea; silicon polyesters, such as those sold under the tradename Silikoftal®, for example Silikoftal HTT commercially available from Evonik and/or combinations thereof. The surfactants, when present, may be present in amounts from 0.01 wt % to 10 wt %, such as from 0.01 to 5 wt %, or even from 0.01 to 2 wt % based on the total solid weight of the composition.

Suitable plasticizers will be known to the person skilled in the art. Examples of suitable plasticizers include, but are not limited to, esters, such as those sold under the tradename Dioplex®, for example Dioplex 907 commercially available from Hallstar; polybutadiene diols, such as those sold under the tradename Krasol®, for example Krasol F3000 commercially available from Cray Valley and those sold under the tradename Poly Bd®, for example Poly bd 605E and Poly bd R45HTLO commercially available from Total; epoxidized soy bean oil, such as EFKA® PL5382 commercially available from BASF; polyurethane diols, such as those sold under the tradename K Flex®, for example K Flex UD 320 commercially available from King Industries; aliphatic diols, such as those sold under the tradename K POL®, for example K POL 8211 commercially available from King Industries; polyols such as those sold under the tradename Cardolite®, for example Cardolite NX-9001, 9007 and 9014 commercially available from Cardolite; thermoplastic methacrylate polymers, such as those sold under the tradename Degalan®, for example Degalan LP 6511 and 6512 commercially available from ROHM; poly vinyl butyrals, such as those sold under the tradename Mowital®, for example Mowital B14S, B16H, BA 20S, B 60HH and B30T commercially available from Kuraray; poly tetrahydrofuran (THF) elastomers (such as those available from BASF); polyesters such as those sold under the tradename Dynapol 9®), for example Dynapol LS 615 and Dynapol LS 415 commercially available from Evonik, those sold under the tradename Vitel®, for example Vitel 3200 commercially available from Bostik and those sold under the tradename Uralac®, for example Uralac CP4197, SH994, SN908 and SH 979 commercially available from DSM; and combinations thereof. The plasticizer, when present, may be used in the UV curable undercoat coating composition and/or UV curable overcoat coating composition in amounts from 0.01 to 20 wt %, such as from 0.01 to 15 wt %, such as from 0.01 to 10 w %, such as from 0.01 to 5 wt %, or even from 0.02 to 2 wt % based on the total weight of the composition.

The UV curable undercoat coating composition and/or the UV curable overcoat coating composition may have any suitable solids content. The solid content of the UV curable undercoat coating composition and/or the UV curable overcoat coating composition may be at least 90 wt % based on the total weight of the UV curable overcoat coating composition.

The solid content of the UV curable undercoat coating composition and/or the UV curable overcoat coating composition may be at least 91 wt %, such as at least 92 wt %, such as at least 93 wt %, such as at least 94 wt %, such as at least 95 wt %, such as at least 96 wt %, such as at least 97 wt %, such as at least 98 wt %, such as at least 99 wt %, such as at least 99.5 wt %, such as at least 99.9 wt % based on the total weight of the composition.

The solid content of the UV curable undercoat coating composition and/or the UV curable overcoat coating composition may be at least 95 wt % based on the total weight of the composition.

The UV curable undercoat coating composition and/or the UV curable overcoat coating composition may comprise a liquid carrier, in an amount of up to 10 wt %, such as up to 5 wt % based on the total weight of the composition.

The UV curable undercoat coating composition and/or the UV curable overcoat coating composition may comprise up to 10, 9, 8, 7, 6, 5, 4, 3, 2, 1, 0.5 or 0.01 wt % of one or more liquid(s) based on the total weight of the composition. The liquid(s) may be present as a result of the use of one or more viscous components. For example, the liquid(s) may be present as part of one or more of the components, i.e., raw ingredients, of the composition and not directly added as a solvent.

The UV curable undercoat coating composition and/or the UV curable overcoat coating composition may comprise up to 10, 9, 8, 7, 6, 5, 4, 3, 2, 1, 0.5 or 0.01 wt % of one or more organic solvents based on the total weight of the composition. The solvent, when present, suitably has sufficient volatility to essentially entirely evaporate from the coating composition during the curing process.

Suitable organic solvents include, but are not limited to, aliphatic hydrocarbons such as mineral spirits and high flash point naphtha; aromatic hydrocarbons such as toluene; xylene; solvent naphtha 100, 150, 150ND, 200 and/or 200ND; those available from Exxon-Mobil Chemical Company under the SOLVESSO® trade name; alcohols such as ethanol, n-propanol, isopropanol, n-butanol, 2-butoxy ethanol and 1-methoxy propan-2-ol, diacetone alcohol; ketones such as acetone, cyclohexanone, methylisobutyl ketone and methyl ethyl ketone; esters such as ethyl acetate, butyl acetate, n-hexyl acetate, dibasic ester commercially available from Sigma Aldrich, propylene glycol methyl ether acetate, butyl glycol acetate, butyl diglycol acetate and RHODIASOLV® RPDE (a blend of succinic and adipic esters commercially available from Solvay); glycols such as butyl glycol and dibutyl glycol; glycol ethers such as methoxypropanol, ethylene glycol monomethyl ether, ethylene glycol monobutyl ether, propylene glycol methyl ether and dipropylene glycol mono methyl ether; and combinations thereof.

The UV curable overcoat coating composition, upon cure, may suitably form a protective coating.

The UV curable overcoat coating composition may be substantially clear. By “substantially clear” is meant that the UV curable overcoat coating composition, once cured, is sufficiently transparent/translucent to allow that the ink layer below is visible.

The UV curable overcoat coating composition may be colourless. By “colourless” is meant that the UV curable overcoat coating composition may be substantially free, may be essentially free or may be completely free of pigment. “Substantially free” refers to coating compositions comprising less than 1 wt % of pigment based on the total solid weight of the coating composition. “Essentially free” refers to coating compositions comprising less than 0.1 wt % of pigment based on the total solid weight of the coating composition. “Completely free” refers to coating compositions comprising less than 0.001 wt % of pigment based on the total solid weight of the coating composition.

### Ink Composition

The multi-layer coating system comprises an ink layer derived from an ink composition.

The term “ink composition” or “ink” (which may be used interchangeably herein) will be well known to a person skilled in the art. For example, by “ink composition”, “ink”, and like terms as used herein, is meant a powder, fluid or paste, such as a gel, sol (colloidal suspension) or solution, that contains at least one colourant and which can be used for printing, i.e., which can be used to impart colour to a surface to produce an image, text or design, etc.

The ink may be operable to be disposed on at least a portion of the UV curable undercoat coating composition or an undercoat coating layer derived therefrom. The UV curable overcoat coating composition, when present, may be operable to be disposed on at least a portion of the ink composition or ink layer derived therefrom.

The ink may be any suitable ink. Suitable inks will be known to a person skilled in the art. The ink may be selected from those that are commonly commercially available for two- and three-piece cans, including those provided by INX, Triton and Sun Chemical.

The ink may comprise a variety of suitable components including, but not limited to, dyes, pigments, resins, solvents and/or additives. Examples of suitable additives include, but are not limited to, lubricants, fluorescents, waxes, curing accelerators, such as photocuring accelerators, and combinations thereof.

The ink may be a liquid or a powder. Such terms, in relation to inks, will be known to a person skilled in the art. However, for the avoidance of doubt, “powder”, and like terms as used herein, refers to materials that are in the form of solid particulates, as opposed to materials which are in the liquid form.

The ink may be applied to at least a portion of the UV curable undercoat coating composition, or undercoat coating layer derived therefrom. One or more inks may be applied. One or more inks may be applied in a particular pattern, such as to impart words and/or images onto the undercoat coating (and underlying substrate). Typically, more than one ink will be applied to impart an image onto the undercoat coating (and underlying substrate).

The ink may be applied by any suitable method. The ink may be applied by digital printing. “Digital printing”, and like terms as used herein, refers to a method of printing from a digital-based image directly to a substrate. As such, the ink layer may be applied directly to a substrate having the undercoat coating thereon. In contrast, offset printing, for example, is a printing technique in which the image is transferred (or “offset”) from a plate to a rubber blanket and then to the printing surface (i.e., the image is not transferred directly to a substrate).

As such, the ink may be an ink suitable for digital printing (as opposed to an offset ink, for example). The ink may be a digital printing ink.

The ink may be applied by digital printing.

The ink may be applied to at least a portion of the UV curable undercoat coating composition, or undercoat coating layer derived therefrom.

The ink may be cured to form an ink layer. The ink may be cured by any suitable method. Suitable methods will be known to a person skilled in the art. For example, the ink may be cured by exposure to radiation. The radiation may be, for example, high-energy radiation or actinic radiation.

A class of high-energy radiation curing includes electron beam curing.

A class of actinic radiation useful herein is ultraviolet light (UV) and other forms of actinic radiation that are normally found in radiation emitted from the sun or from artificial sources such as, for example, Type RS Sunlamps, carbon arc lamps, gas discharge tubes, such as xenon arc lamps, mercury vapor lamps, tungsten halide lamps, pulsed and unpulsed TV lasers, UV spot radiators, such as UV-emitting diodes and black light tubes, electrodeless microwave powered lamps, and the like. Ultraviolet radiation may be used most efficiently ink composition contains a suitable photocuring rate accelerator. Curing periods may be adjusted to be very short and hence commercially economical by proper choice of ultraviolet source, photocuring rate accelerator and concentration thereof and/or temperature.

The ink composition may be UV-curable.

### Multi-Layer System

The multi-layer coating system may be applied to any suitable substrate. The multi-layer coating system may be applied to any suitable substrate and cured. For example, the UV curable undercoat coating composition and the ink composition may each be applied to a substrate and cured to form a multi-layer coating system comprising an undercoat coating layer and an ink layer. For example, the ink composition and the UV curable overcoat composition may each be applied to a substrate and cured to form a multi-layer coating system comprising an ink layer and an overcoat coating layer.

The multi-layer coating system may comprise a UV curable undercoat composition and a UV curable coating composition, each in accordance with the present invention. Thus, the multi-layer coating system may comprise:
i) an undercoat coating layer derived from a UV curable coating composition according to the present invention;
ii) an ink layer directly disposed on the undercoat coating layer, said ink layer being derived from an ink composition; and
iii an overcoat coating layer directly disposed on the ink layer, said overcoat coating layer being derived from a UV curable overcoat coating composition according to the present invention.

Such multi-layer coating systems may be applied to any of the substrates disclosed herein.

Each layer may independently be cured by any suitable method. For example, the UV curable undercoat coating composition may be partially cured or fully cured prior to the application of the ink composition. The ink composition may be partially cured or fully cured prior to the application of the UV curable overcoat coating composition.

The UV curable undercoat coating composition may be fully cured prior to the application of the ink composition.

The ink composition may be fully cured prior to the application of the UV curable overcoat coating composition.

It will be appreciated by a person skilled in the art that, for example, when the ink composition is applied to the UV curable undercoat coating composition prior to cure of the UV curable undercoat coating composition, the application of the ink composition will be so-called “wet-on-wet” application. The UV curable undercoat coating composition and ink composition may then be cured at the same time.

The UV curable undercoat coating composition and/or the UV curable overcoat coating composition may be cured according to the methods described herein, such as by exposure to UV radiation.

The ink composition may be cured according to the methods as defined herein, such as by exposure to UV radiation.

### Further Coating Layers

The multi-layer coating systems of the present invention may comprise one or more further coating layers.

The further coating layers may be derived from one or more further coating composition(s). The further coating layers may comprise any suitable paint such as those containing, for example, epoxy resins; polyester resins; polyurethane resins; polysiloxane resins; hydrocarbon resins or combinations thereof. The further coating layers may be a liquid coating or a powder coating.

The multi-layer coating system may comprise a primer coating layer derived from a primer coating composition. “Primer coating layers”, “primer coating compositions” and the like, as used herein, refer to coating layers that are applied under one or more of the coating or ink layers defined therein. For example, a primer coating layer may be applied under the ink layer as defined herein and/or under the undercoat coating layer derived from a UV curable undercoat coating composition as defined herein. For the avoidance of doubt, “primer coating layers”, “primer coating compositions”, etc., are distinguished from the undercoat coating layer(s) derived from the UV curable undercoat coating compositions of the present invention (and as defined herein).

The primer coating layer may be derived from a thermally curable primer coating composition.

When the substrate is an aluminium package, such as an aluminium monobloc aerosol can and/or tube, the multi-layer coating system may comprise a primer layer derived from a primer coating composition, an ink layer derived from an ink composition, and an overcoat coating layer derived from a UV curable overcoat coating composition of the present invention (and as defined herein).

The multi-layer coating system may comprise a topcoat coating layer derived from a topcoat coating composition. “Top coat coating layers”, “top coat coating compositions” and the like, as used herein, refer to coating layers that are applied on top of one or more of the coating or ink layers defined herein. For the avoidance of doubt, “top coat coating layers”, “top coat coating compositions”, etc., are distinguished from the overcoat coating layer(s) derived from the UV curable overcoat coating compositions of the present invention (and as defined herein).

The topcoat coating layer may be derived from a thermally curable topcoat coating composition.

The primer coating composition and/or topcoat coating composition may comprise one or more components selected from, but not limited to, resin binders, solvents, crosslinker materials, additives, and combinations thereof. The primer composition and/or topcoat coating composition may comprise a resin binder and one or more additives. The primer composition and/or topcoat coating composition comprise a photoinitiator, for example, when it is desired for said primer composition and/or topcoat coating composition is UV curable.

Examples of suitable resin binders which may be present in the primer coating compositions and/or topcoat coating compositions include, but are not limited to, polyester resins; acrylic resins; polyvinyl chloride (PVC) resins; alkyd resins; polyurethane resins; polysiloxane resins; epoxy resins or combinations thereof.

Examples of suitable solvents which may be present in the primer coating compositions and/or topcoat coating compositions are as defined herein in relation to the UV curable undercoat coating composition and/or the UV curable overcoat coating compositions. The primer coating compositions and/or topcoat coating composition may be solvent-borne. By “solvent-borne” is meant that the composition comprises one or more organic solvents as a carrier and up to 20 vol %, such as up to 10 vol %, such as up to 5 vol %, such as up to 1 vol % of water based on the total volume of carrier present. The primer coating composition and/or topcoat coating composition may comprise 100 vol % solvent based on the total volume of carrier present.

Examples of suitable crosslinker materials which may be present in the primer coating composition and/or topcoat coating composition include, but are not limited to, the following: phenolic resins (or phenol-formaldehyde resins); aminoplast resins (or triazine-formaldehyde resins); amino resins; epoxy resins; epoxy-mimic resins, such as those based on bisphenols and other bisphenol A (BPA) replacements; isocyanate resins, isocyanurate resins, such as triglycidylisocyanurate; hydroxy (alkyl) amide resins, such as β-hydroxy (alkyl) amide resins; hydroxy (alkyl) urea resins; carbodiimide resins, such as polycarbodiimide resins; oxazolines; and combinations thereof.

Non-limiting examples of phenolic resins are those formed from the reaction of a phenol with an aldehyde or a ketone, such as from the reaction of a phenol with an aldehyde, such as from the reaction of a phenol with formaldehyde or acetaldehyde, or even from the reaction of a phenol with formaldehyde. Non-limiting examples of phenols which may be used to form phenolic resins are phenol, butyl phenol, xylenol and cresol. General preparation of phenolic resins is described in “The Chemistry and Application of Phenolic Resins or Phenoplasts”, Vol V, Part I, edited by Dr Oldring; John Wiley and Sons/Cita Technology Limited, London, 1997. The phenolic resins are of the resol type. By “resol type” is meant resins formed in the presence of a basic (alkaline) catalyst and optionally an excess of formaldehyde. Examples of suitable commercially available phenolic resins include, but are not limited to, those sold under the trade name PHENODUR® commercially available from Cytec Industries, such as PHENODUR EK-827, PHENODUR VPR1785, PHENODUR PR 515, PHENODUR PR516, PHENODUR PR 517, PHENODUR PR 285, PHENODUR PR612, PHENODUR 520, PHENODUR 307 or PHENODUR PH2024; resins sold under the trade name BAKELITE® commercially available from Momentive, such as BAKELITE 6582 LB, BAKELITE 6535, BAKELITE PF9989, BAKELITE PF 7295 LB, BAKELITE 6736 LG, BAKELITE 6572 LB or BAKELITE PF6581; SFC 112 commercially available from Schenectady; DUREZ® 33356 commercially available from SHHPP; Curaphen 40-862 commercially available from Bitrez; BDP2220/DF0181 commercially available from Bitrez; BURNOCK PH2891 commercially available from DIC Corporation; Askofen R9500 commercially available from Ask Chemicals; or combinations thereof.

Non limiting examples of isocyanate resins include, but are not limited to, isophorone diisocyanate (IPDI), such as those sold under the trade name DESMODUR® commercially available from Covestro, for example DESMODUR VP-LS 2078/2 or DESMODUR PL 340 or those sold under the trade name VESTANAT® commercially available from Evonik, for example VESTANANT B 1370, VESTANAT B 118 6A or VESTANAT B 1358 A; blocked aliphatic polyisocyanate based on hexamethylene diisocyanate (HDI), such as those sold under the trade name DESMODUR® commercially available from Covestro, for example DESMODUR BL3370 or DESMODUR BL 3175 SN, those sold under the trade name DURANATE® commercially available from Asahi KASEI, for example DURANATE MF-K60X, those sold under the trade name TOLONATE® commercially available from Perstorp, for example TOLONATE D2 or those sold under the trade name TRIXENE® commercially available from Baxenden, for example TRIXENE-BI-7984 or TRIXENE 7981; or combinations thereof.

Non-limiting examples of aminoplast resins include those which are formed from the reaction of a triazine such as melamine or benzoguanamine with formaldehyde. The resultant compounds may be etherified with an alcohol such as methanol, ethanol, butanol or combinations thereof. The preparation and use of aminoplast resins is described in “The Chemistry and Applications of Amino Crosslinking Agents or Aminoplast”, Vol V, Part II, page 21 ff., edited by Dr Oldring; John Wiley and Sons/Cita Technology Limited, London, 1998. Examples of suitable commercially available aminoplast resins include, but are not limited to, those sold under the tradename MAPRENAL® such as MAPRENAL MF980, MF 820/60IB or 821/84B commercially available from Prefere Resins and those sold under the tradename CYMEL® such as CYMEL 303, CYMEL 651E and CYMEL 1128 commercially available from Allnex.

Examples of additives which may be present in the primer composition and/or topcoat coating composition include, but are not limited, colorants, plasticizers, abrasion-resistant particles, anti-oxidants, hindered amine light stabilizers, UV light absorbers and stabilizers, surfactants, flow control agents, thixotropic agents, fillers, organic co-solvents, reactive diluents, catalysts, grind vehicles, lubricants, waxes and other customary auxiliaries, suitable examples of which are as defined herein in relation to the UV curable undercoat coating composition and/or the UV curable overcoat coating composition.

The primer coating composition, upon cure, may suitably form a protective coating, i.e., it may form a coating operable to protect the substrate.

The topcoat coating composition, upon cure, may suitably form a protective coating, i.e., it may form a coating operable to protect the ink layer.

The topcoat coating composition may be substantially clear. The topcoat coating composition may be colourless.

The primer coating composition and/or topcoat coating composition may be cured by any means. For example, the primer coating composition and/or topcoat coating composition may be heat and/or UV curable, such as heat curable. When the primer coating composition and/or topcoat coating composition is UV curable, the primer composition and/or topcoat coating composition may comprise a photoinitiator. The primer coating composition and/or topcoat coating composition may be cured by exposure to heat. For example, the primer composition and/or topcoat coating composition may be cured by heating at 130-230°C for 1-15 minutes.

Each coating composition, including the UV curable coating composition(s) as defined herein and, optionally, one or more further coating compositions, may each independently be applied to the substrate once or multiple times.

### Substrate

As defined herein, the multi-layer coating system may be applied to a substrate. The substrate may be any suitable substrate. The substrate may be a package. As such, the multi-layer coating system may be applied to a package.

The package may be a metal package. Examples of metal packages include, but are not limited to, food and/or beverage packaging, components used to fabricate such packaging or monobloc aerosol cans and/or tubes. The food and/or beverage packaging may be a can. Examples of suitable cans include, but are not limited to, two-piece cans, three-piece cans and the like. Suitable examples of monobloc aerosol cans and/or tubes include, but are not limited to, deodorant and hair spray containers. Monobloc aerosol cans and/or tubes may be aluminium monobloc aerosol cans and/or tubes.

The package may be for use in packaging cosmetics, food products, beverages and/or pharmaceutical products.

The package may comprise aluminium. For example, the package may be an aluminium package. The package may be an aluminium monobloc aerosol can, an aluminium monobloc aerosol tube or flexible aluminium packaging. Such aluminum packages are typically used for packaging personal care products, such as cosmetics, and/or pharmaceutical products.

The multi-layer coating system may be applied to food and/or beverage packaging and/or monobloc aerosol cans and/or tubes or components used to fabricate such packaging.

The multi-layer coating system may be applied to a monobloc aerosol cans, a monobloc aerosol tube, or components used to fabricate such packaging.

The multi-layer coating system may be applied to an uncoated substrate. For the avoidance of doubt, an uncoated substrate extends to a surface that is cleaned prior to application.

The application of various pre-treatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This can be true when the contents of the can are acidic in nature. The coatings applied to the interior of metal cans also help prevent corrosion in the headspace of the cans, which is the area between the fill line of the product and the can lid; corrosion in the headspace can be problematic with food products having a high salt content. Coatings can also be applied to the exterior of metal cans. Certain coating compositions of the present invention may be applicable for use with coiled metal stock, such as the coiled metal stock from which the ends of cans are made (“can end stock”), and end caps and closures are made (“cap/closure stock”). Since coatings designed for use on can end stock and cap/closure stock may be applied prior to the piece being cut and stamped out of the coiled metal stock, they may be flexible and extensible. For example, such stock may be coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, such as by means of a pull tab. For caps and closures, the cap/closure stock may be coated, such as by roll coating, and the cap or closure stamped out of the stock; it is possible, however, to coat the cap/closure after formation. Coatings for cans subjected to relatively stringent temperature and/or pressure requirements should also be resistant to popping, corrosion, blushing and/or blistering.

In more detail, a “package” is anything used to contain another item, such as for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which may range from several months to years. Thus, the present “package” is distinguished from a storage container or bakeware in which a consumer might make and/or store food; such a container would only maintain the freshness or integrity of the food item for a relatively short period. A package according to the present invention can be made of metal or non-metal, for example, plastic or laminate, and be in any form. An example of a suitable package is a laminate tube. Packages coated according to the present invention can also include plastic bottles, plastic tubes, laminates and flexible packaging, such as those made from PE, PP, PET and the like. Such packaging could hold, for example, food, toothpaste, personal care products and the like.

Another example of a suitable package is metal can. The term “metal can” includes any type of metal can, container or any type of receptacle or portion thereof that is sealed by the food and/or beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which may be stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products.

The package may be a food or beverage preparation capsule, for example, a capsule for the preparation of beverages such as coffee or coffee type beverages, tea, chocolate, milk (for infants or otherwise), broth, cider etc. In use, such a capsule is placed into a compatible machine whereupon water, which may be hot and/or pressurised, is contacted with the beverage ingredient by passing through the capsule to thereby cause beverage preparation by, for example dissolving, extracting, brewing or other interaction.

The packaging may be a general line product, such as drums, paint cans and/or pails, for example. The packaging may be a speciality product, such as a metal container, or even a hinged metal container (for confectionary, lighter fluid, tobacco etc.), for example, an Altoid container. The packaging may be an aluminium foil container, for example.

The multi-layer coating system can be applied to the interior and/or the exterior of the package. The multi-layer coating system may be applied to the exterior of the package.

The multi-layer coating system can be applied to the “side stripe” of a metal can, which will be understood as the seam formed during fabrication of a three-piece can. The multi-layer coating system could also be applied as a rim coat to the bottom of the can. The rim coat functions to reduce friction for improved handling during the continued fabrication and/or processing of the can. The coating composition can also be applied to caps and/or closures; such application can include, for example, a protective varnish that is applied before and/or after formation of the cap/closure and/or a pigmented enamel post applied to the cap, such as those having a scored seam at the bottom of the cap.

Decorated can stock can also be partially coated externally with the multi-layer coating system described herein, and the decorated, coated can stock used to form various metal cans.

The package may comprise a monobloc aerosol can, a monobloc aerosol can, or a plastic package, such as an extruded plastic tube.

The package may comprise a plastic package.

As such, the present discourse extends to a package coated on at least a portion thereof with a multi-layer coating system according to the present invention, wherein the package is a monobloc aerosol can, a monobloc aerosol can, or an extruded plastic tube.

The plastic package may be formed from polyethylene and/or polypropylene.

The plastic package may be an extruded and/or injection moulded plastic tube, such as an extruded plastic tube.

The plastic package may be an extruded and/or injection moulded plastic tube comprising polyethylene and/or polypropylene, such as an extruded plastic tube comprising polyethylene and/or polypropylene.

The UV curable undercoat coating composition and/or the UV curable overcoat coating composition may be a single component coating composition (often referred to as a 1K coating composition) or a multiple component coating composition, such as a two-component coating composition (often referred to as a 2K coating composition). Such terminology is well known in the art. In a multiple component coating composition, the components are provided separately but introduced to each other (by mixing, for example) prior to application. This could be hours before application, for example up to 24 hours before application, or up to 12 hours before application or up to 8 hours before application or up to 4 hours before application. In some instances, the multiple components may be introduced to each other (such as by mixing) during the application process, such as in line mixing, for example. If the UV curable undercoat coating composition and/or the UV curable overcoat coating composition is a multiple component coating composition, such as a 2-component coating composition, one or more material(s) may be provided in a first component, while the other material(s) may be provided in a further component, (such as a second component). For example, the epoxy material may be provided in a first component and the photoinitiator may be provided in a further component (such as a second component).

The multi-layer coating system may be applied to at least a portion of the package. For example, the multi-layer coating system may be applied to at least a portion of a plastic tube. For example, the multi-layer coating system may be applied to at least a portion of a monobloc aerosol can or a monobloc aerosol tube.

The multi-layer coating system may be applied to any suitable surface of the substrate (package). For example, the multi-layer coating system may be applied to at least a portion of an internal and/or external surface of a package. For example, the multi-layer coating system may be applied to at least a portion of an external surface of a package.

The multi-layer coating system may be applied to a substrate before or after the substrate is formed into a package. For example, the multi-layer coating system may be applied to a flat sheet prior to the substrate (flat sheet) being formed into a package. For example, the multi-layer coating system may be applied to a pre-formed, or partially formed, package.

The multi-layer coating system may be applied to a pre-formed package.

Each layer of the multi-layer coating system may be applied to the substrate (package) by any suitable method. Methods of applying a coating composition and/or ink composition will be known to a person skilled in the art. Suitable methods include, but are not limited to, electrocoating such as electrodeposition; spraying; electrostatic spraying; dipping; rolling; brushing; and the like. The UV curable undercoat coating composition and/or the UV curable overcoat coating composition may be applied to a substrate (package) by lamination. For example, a film may be formed from the coating composition, which film may subsequently be applied to a substrate (package) by lamination thereon.

The UV curable undercoat coating composition and/or the UV curable overcoat coating composition may be applied to any suitable dry film thickness. The UV curable undercoat coating composition and/or the UV curable overcoat coating composition may be applied to a dry film thickness from 0.5 to 100 microns (μm), suitably from 0.5 to 75 μm, such as from 1 to 50 μm, such as from 1 to 40 μm, such as from 1 to 20 μm, such as from 1 to 10 μm.

### SELECTED DEFINITIONS

The term “alk” or “alkyl”, as used herein unless otherwise defined, relates to saturated hydrocarbon radicals being straight, branched, cyclic or polycyclic moieties or combinations thereof and contain 1 to 20 carbon atoms, such as 1 to 10 carbon atoms, such as 1 to 8 carbon atoms, such as 1 to 6 carbon atoms, or even 1 to 4 carbon atoms. These radicals may be optionally substituted with a chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, aryl or Het, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from methyl, ethyl, n-propyl, isopropyl, n-butyl, isobutyl, sec-butyl, tert-butyl, 2-methylbutyl, pentyl, iso-amyl, hexyl, cyclohexyl, 3-methylpentyl, octyl and the like. The term “alkylene”, as used herein, relates to a bivalent radical alkyl group as defined above. For example, an alkyl group such as methyl which would be represented as —CH³, becomes methylene, —CH²—, when represented as an alkylene. Other alkylene groups should be understood accordingly.

The term “alkenyl”, as used herein, relates to hydrocarbon radicals having, such as up to 4, double bonds, being straight, branched, cyclic or polycyclic moieties or combinations thereof and containing from 2 to 18 carbon atoms, such as 2 to 10 carbon atoms, such as from 2 to 8 carbon atoms, such as 2 to 6 carbon atoms, or even 2 to 4 carbon atoms. These radicals may be optionally substituted with a hydroxyl, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or alkyl, and/or be interrupted by oxygen or sulphur atoms, or by silano or dialkylsiloxane groups. Examples of such radicals may be independently selected from alkenyl groups include vinyl, allyl, isopropenyl, pentenyl, hexenyl, heptenyl, cyclopropenyl, cyclobutenyl, cyclopentenyl, cyclohexenyl, 1-propenyl, 2-butenyl, 2-methyl-2-butenyl, isoprenyl, farnesyl, geranyl, geranylgeranyl and the like. The term “alkenylene”, as used herein, relates to a bivalent radical alkenyl group as defined above. For example, an alkenyl group such as ethenyl which would be represented as —CH═CH₂, becomes ethenylene, —CH═CH—, when represented as an alkenylene. Other alkenylene groups should be understood accordingly.

The term “alkynyl”, as used herein, relates to hydrocarbon radicals having, such as up to 4, triple bonds, being straight, branched, cyclic or polycyclic moieties or combinations thereof and having from 2 to 18 carbon atoms, such as 2 to 10 carbon atoms, such as from 2 to 8 carbon atoms, such as from 2 to 6 carbon atoms, or even from 2 to 4 carbon atoms. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O)SR²⁷, C(S)NR²⁵R²⁶, or aryl, wherein R¹⁹ to R²⁷ each independently represent hydrogen, aryl or lower alkyl, and/or be interrupted by oxygen or sulphur atoms, or by silano or dialkylsiloxane groups. Examples of such radicals may be independently selected from alkynyl radicals include ethynyl, propynyl, propargyl, butynyl, pentynyl, hexynyl and the like. The term “alkynylene”, as used herein, relates to a bivalent radical alkynyl group as defined above. For example, an alkynyl group such as ethynyl which would be represented as —C≡CH, becomes ethynylene, —C≡C—, when represented as an alkynylene. Other alkynylene groups should be understood accordingly.

The term “aryl” as used herein, relates to an organic radical derived from an aromatic hydrocarbon by removal of one hydrogen, and includes any monocyclic, bicyclic or polycyclic carbon ring of up to 7 members in each ring, wherein a ring is aromatic. These radicals may be optionally substituted with a hydroxy, chloro, bromo, iodo, cyano, nitro, OR¹⁹, OC(O)R²⁰, C(O)R²¹, C(O)OR²², NR²³R²⁴, C(O)NR²⁵R²⁶, SR²⁷, C(O) SR²⁷, C(S)NR²⁵R²⁶, or aryl, wherein R¹⁹ to R27 each independently represent hydrogen, aryl or lower alkyl, and/or be interrupted by oxygen or sulphur atoms, or by silano or dialkylsilcon groups. Examples of such radicals may be independently selected from phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-4-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl, tetrahydronaphthyl, indanyl, biphenyl, phenanthryl, anthryl or acenaphthyl and the like. The term “arylene”, as used herein, relates to a bivalent radical aryl group as defined above. For example, an aryl group such as phenyl which would be represented as -Ph, becomes phenylene, -Ph-, when represented as an arylene. Other arylene groups should be understood accordingly.

For the avoidance of doubt, the reference to alkyl, alkenyl, alkynyl, aryl or aralkyl in composite groups herein should be interpreted accordingly, for example the reference to alkyl in aminoalkyl or alk in alkoxyl should be interpreted as alk or alkyl above etc.

As used herein, unless otherwise expressly specified, all numbers such as those expressing values, ranges, amounts or percentages may be read as if prefaced by the word “about”, even if the term does not expressly appear. Also, the recitation of numerical ranges by endpoints includes all integer numbers and, where appropriate, fractions subsumed within that range (e.g., 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

Singular encompasses plural and vice versa. For example, although reference is made herein to “a” crosslinker material, “a” thermoplastic particle, “an” epoxy compound, and the like, one or more of each of these and any other components can be used. As used herein, the term “polymer” refers to oligomers and both homopolymers and copolymers, and the prefix “poly” refers to two or more. Including, for example and like terms means including for example but not limited to.

The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present disclosure has been described in terms of “comprising”, the coating compositions detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

The present disclosure may be according to any one of the following numbered aspects:

1. A multi-layer coating system comprising: i) an undercoat coating layer derived from a UV curable undercoat coating composition, the UV curable undercoat coating composition comprising: a) an epoxy material; b) a polyol material having a hydroxyl value (OHV) of at least 35 mg KOH/g and/or a diketone-functional material; and c) a photoinitiator; and ii) an ink layer derived from an ink composition.

2. The multi-layer coating system according to aspect 1, wherein the ink layer is disposed directly on the undercoat coating layer.

3. The multi-layer coating system according to any one of aspects 1 or 2, wherein the ink composition is digitally printed.

4. The multi-layer coating system according to any one of aspects 1-3, wherein the UV curable undercoat coating composition has a solid content of at least 95 wt % based on the total weight of the composition.

5. The multi-layer coating system according to any one of aspects 1-4, wherein the UV curable undercoat coating composition comprises a polyol material in an amount of at least 2 wt %, such as at least 5 wt %, such as from 5 to 30 wt %, based on the total solid weight of the composition

6. The multi-layer coating system according to any one of aspects 1-5, wherein the UV curable undercoat coating composition comprises a diketone-functional material such as an acetoacetate-functional material, in an amount of at least 2 wt %, such as at least 5 wt %, such as from 5 to 30 wt %, based on the total solid weight of the composition.

7. The multi-layer coating system according to any one of aspects 1-6, wherein the epoxy material comprises a cycloaliphatic epoxy resin.

8. The multi-layer coating system according to any one of aspects 1-7, wherein UV curable undercoat coating composition comprises from 55 to 85 wt % epoxy material based on the total solid weight of the composition.

9. The multi-layer coating system according to any one of aspects 1-8, wherein the photoinitiator comprises a cationic photoinitiator.

10. The multi-layer coating system according to any one of aspects 1-9, wherein the UV curable undercoat coating composition is substantially free of polytetrafluoroethylene (PTFE).

11. The multi-layer coating system according to any one of aspects 1-10, wherein the polyol material has a hydroxyl value (OHV) of at least 50 mg KOH/g, such as at least 100 mg KOH/g.

12. The multi-layer coating system according to any one of aspects 1-11, wherein the polyol material has an acid value (AV) up to 10 mg KOH/g.

13. The multi-layer coating system according to any one of aspects 1-12, wherein the polyol material has a number average molecular weight (Mn) up to 5,000 Da.

14. The multi-layer coating system according to any one of aspects 1-13, wherein the UV curable undercoat coating composition further comprises a polyester material having a hydroxyl value (OHV) up to 45 mg KOH/g, optionally wherein the polyester material is present in the UV curable undercoat coating composition in an amount from 6 to 20 wt % based on the total solid weight of the composition.

15. The multi-layer coating system according to any one of aspects 1-14, wherein the UV curable undercoat coating composition comprises from 1 to 5 wt % photoinitiator based on the total solid weight of the composition.

16. A package coated on at least a portion thereof with a multi-layer coating system according to any one of aspects 1-15.

17. A plastic package coated on at least a portion thereof with a multi-layer coating system according to any one of aspects 1-15.

18. The package according to aspect 17, wherein the package comprises polyethylene and/or polypropylene.

19. The package according to any one of aspects 17 or 18, wherein the package comprises an extruded and/or injection moulded plastic tube, such as an extruded plastic tube.

20. A multi-layer coating system comprising: i) an undercoat coating layer derived from a UV curable undercoat coating composition according to any one of aspects 1-15; ii) an ink layer derived from an ink composition; and iii) a topcoat coating layer derived from a topcoat coating composition.

21. The multi-layer coating system according to aspect 20, wherein the ink layer is disposed directly on the undercoat coating layer.

22. The multi-layer coating system according to any one of aspects 20 or 21, wherein the topcoat coating layer is disposed directly on the ink layer.

23. The multi-layer coating system according to any one of aspects 20-22, wherein the topcoat coating composition is thermally curable.

24. The multi-layer coating system according to any one of aspects 20-23, wherein the topcoat coating composition comprises one or more components selected from: resin binders, solvents, crosslinker materials, and additives.

25. The multi-layer coating system according to any one of aspects 20-24, wherein the topcoat coating composition is solvent-borne.

26. The multi-layer coating system according to any one of aspects 24 or 25, wherein the topcoat coating composition comprises one or more resin(s) selected from a polyester resin, an acrylic resin, a polyvinyl chloride (PVC) resin, an alkyd resin, a polyurethane resins, a polysiloxane resin, an epoxy resin, or a combination thereof.

27. The multi-layer coating system according to any one of aspects 24-26, wherein the topcoat coating composition comprises one or more crosslinker material(s) selected from phenolic resins (or phenol-formaldehyde resins); aminoplast resins (or triazine-formaldehyde resins); amino resins; epoxy resins; epoxy-mimic resins, such as those based on bisphenols and other bisphenol A (BPA) replacements; isocyanate resins, isocyanurate resins, such as triglycidylisocyanurate; hydroxy (alkyl) amide resins, such as β-hydroxy (alkyl) amide resins; hydroxy (alkyl) urea resins; carbodiimide resins, such as polycarbodiimide resins; oxazolines; and combinations thereof.

27. The multi-layer coating system according to aspect 27, wherein the crosslinker material comprises a phenolic resin, an aminoplast resin, an isocyanate resin, an isocyanurate resin, or a combination thereof.

28. A package coated on at least a portion thereof with a multi-layer coating system according to any one of aspects 20-27.

29. A plastic package coated on at least a portion thereof with a multi-layer coating system according to any one of aspects 20-27.

30. The package according to aspect 29, wherein the package comprises polyethylene and/or polypropylene.

31. The package according to any one of aspects 29 or 30, wherein the package comprises an extruded and/or injection moulded plastic tube, such as an extruded plastic tube.

32. A multi-layer coating system for an aluminium package comprising: i) an ink layer, said ink layer being derived from an ink composition; and ii) an overcoat coating layer, said overcoat coating layer derived from a UV curable overcoat coating composition, the UV curable overcoat coating composition comprising: a2) an epoxy material; b2) a polyol material and/or a diketone-functional material; and c2) a photoinitiator.

33. The multi-layer coating system according to aspect 32, wherein the overcoat coating layer is disposed directly on the ink layer.

34. The multi-layer coating system according to any one of aspects 32 or 33, wherein the ink composition is digitally printed.

35. The multi-layer coating system according to any one of aspects 32-34, wherein the UV curable overcoat coating composition has a solid content of at least 95 wt % based on the total weight of the composition.

36. The multi-layer coating system according to any one of aspects 32-35, wherein the UV curable overcoat coating composition comprises a polyol material in an amount of at least 2 wt %, such as at least 5 wt %, such as from 5 to 30 wt %, based on the total solid weight of the composition.

37. The multi-layer coating system according to any one of aspects 32-36, wherein the UV curable overcoat coating composition comprises a diketone-functional material, such as an acetoacetate-functional material, in an amount of at least 2 wt %, such as at least 5 wt %, such as from 5 to 30 wt %, based on the total solid weight of the composition.

38. The multi-layer coating system according to any one of aspects 32-37, wherein the epoxy material comprises a cycloaliphatic epoxy resin.

39. The multi-layer coating system according to any one of aspects 32-38, wherein the UV curable overcoat coating composition comprises from 55 to 85 wt % epoxy material based on the total solid weight of the composition.

40. The multi-layer coating system according to any one of aspects 32-39, wherein the photoinitiator comprises a cationic photoinitiator.

41. The multi-layer coating system according to any one of aspects 32-40, wherein the overcoat coating composition comprises a reactive diluent, for example a reactive diluent comprising an oxetane group.

42. The multi-layer coating system according to any one of aspects 32-41, wherein the UV curable overcoat coating composition comprises from 1 to 10 wt % photoinitiator based on the total solid weight of the composition.

43. The multi-layer coating system according to any one of aspects 32-42, wherein the UV curable overcoat coating composition is substantially free of polytetrafluoroethylene (PTFE).

44. The multi-layer coating system according to any one of aspects 32-43, wherein the polyol material has a hydroxyl value (OHV) of at least 25 mg KOH/g.

45. The multi-layer coating system according to any one of aspects 32-44, wherein the UV curable overcoat coating composition comprises a wax, for example a wax comprising a micronized wax and/or a micronized polysaccharide.

46. The multi-layer coating system according to any one of aspects 32-45, wherein the UV curable overcoat coating composition further comprises a (meth)acrylate-functional material.

47. The multi-layer coating system according to aspect 46, wherein the UV curable overcoat coating composition further comprises a free-radical initiator.

48. The multi-layer coating system according to any one of aspects 32-47, wherein the aluminium package is a monobloc aerosol can and/or tube.

49. The multi-layer coating system according to any one of aspects 32-48, wherein the aluminium package is for use in packaging cosmetics, food products, beverages and/or pharmaceutical products, for example in packaging cosmetics and/or pharmaceutical products.

50. A multi-layer coating system for an aluminium package comprising: i) a primer layer derived from a primer coating composition, ii) an ink layer, said ink layer being derived from an ink composition; and ii) an overcoat coating layer, said overcoat coating layer derived from a UV curable overcoat coating composition according to any one of aspects 32-49.

51. The multi-layer coating system according to aspect 50, wherein the ink layer is disposed directly on the primer coating layer.

52. The multi-layer coating system according to any one of aspects 50 or 51, wherein the overcoat coating layer is disposed directly on the ink layer.

53. The multi-layer coating system according to any one of aspects 50-52, wherein the ink composition is digitally printed.

54. The multi-layer coating system according to any one of aspects 50-53, wherein the primer coating composition is thermally curable.

55. The multi-layer coating system according to any one of aspects 50-54, wherein the primer coating composition comprises one or more components selected from: resin binders, solvents, crosslinker materials, and additives.

56. The multi-layer coating system according to any one of aspects 50-55, wherein the primer coating composition is solvent-borne.

57. The multi-layer coating system according to any one of aspects 55 or 56, wherein the primer coating composition comprises one or more resin(s) selected from a polyester resin, an acrylic resin, a polyvinyl chloride (PVC) resin, an alkyd resin, a polyurethane resins, a polysiloxane resin, an epoxy resin, or a combination thereof.

58. The multi-layer coating system according to any one of aspects 55-57, wherein the primer coating composition comprises one or more crosslinker material(s) selected from phenolic resins (or phenol-formaldehyde resins); aminoplast resins (or triazine-formaldehyde resins); amino resins; epoxy resins; epoxy-mimic resins, such as those based on bisphenols and other bisphenol A (BPA) replacements; isocyanate resins, isocyanurate resins, such as triglycidylisocyanurate; hydroxy (alkyl) amide resins, such as β-hydroxy (alkyl) amide resins; hydroxy (alkyl) urea resins; carbodiimide resins, such as polycarbodiimide resins; oxazolines; and combinations thereof.

59. The multi-layer coating system according to aspect 58, wherein the crosslinker material comprises a phenolic resin, an aminoplast resin, an isocyanate resin, an isocyanurate resin, or a combination thereof.

60. The multi-layer coating system according to any one of aspects 50-59, wherein the aluminium package is a monobloc aerosol can and/or tube.

61. The multi-layer coating system according to any one of aspects 50-59, wherein the aluminium package is for use in packaging cosmetics, food products, beverages and/or pharmaceutical products, for example in packaging cosmetics and/or pharmaceutical products.

62. An aluminium package coated on at least a portion thereof with a multi-layer coating system according to any one of aspects 32-49.

63. An aluminium package coated on at least a portion thereof with a multi-layer coating system according to any one of aspects 50-61.

64. An aluminium package according to any one of aspects 62 or 63, wherein the package is for use in packaging cosmetics, food products, beverages and/or pharmaceutical products, for example in packaging cosmetics and/or pharmaceutical products.

65. The aluminium package according to any one of aspects 62-64, wherein the aluminium package is a monobloc aerosol can and/or tube.

66. A method of producing a package, the method comprising the steps of: I) applying a UV curable undercoat coating composition comprising: a) an epoxy material; b) a polyol material having a hydroxyl value (OHV) of at least 35 mg KOH/g and/or a diketone-functional material; and c) a photoinitiator to at least a portion of a package; II) curing the UV curable undercoat coating composition to form a cured undercoat coating layer; III) applying an ink composition on at least a portion of the undercoat coating layer; and IV) curing the ink composition to from an ink layer.

67. The method according to aspect 66, wherein the ink composition is applied by digital printing.

68. The method according to any one of aspects 66 or 67, wherein the UV curable undercoat coating composition has a solid content of at least 95 wt % based on the total weight of the composition.

69. The method according to any one of aspects 66-68, wherein the UV curable undercoat coating composition comprises a polyol material in an amount of at least 2 wt %, such as at least 5 wt %, such as from 5 to 30 wt %, based on the total solid weight of the composition

70. The method according to any one of aspects 66-69, wherein the UV curable undercoat coating composition comprises a diketone-functional material such as an acetoacetate-functional material, in an amount of at least 2 wt %, such as at least 5 wt %, such as from 5 to 30 wt %, based on the total solid weight of the composition.

71. The method according to any one of aspects 66-70, wherein the epoxy material comprises a cycloaliphatic epoxy resin.

72. The method according to any one of aspects 66-71, wherein UV curable undercoat coating composition comprises from 55 to 85 wt % epoxy material based on the total solid weight of the composition.

73. The method according to any one of aspects 66-72, wherein the photoinitiator comprises a cationic photoinitiator.

74. The method according to any one of aspects 66-73, wherein the UV curable undercoat coating composition is substantially free of polytetrafluoroethylene (PTFE).

75. The method according to any one of aspects 66-74, wherein the polyol material has a hydroxyl value (OHV) of at least 50 mg KOH/g, such as at least 100 mg KOH/g.

76. The method according to any one of aspects 66-75, wherein the polyol material has an acid value (AV) up to 10 mg KOH/g.

77. The method according to any one of aspects 66-76, wherein the polyol material has a number average molecular weight (Mn) up to 5,000 Da.

78. The method according to any one of aspects 66-77, wherein the UV curable undercoat coating composition further comprises a polyester material having a hydroxyl value (OHV) of less than 35 mg KOH/g, such as up to 30 mg KOH/g, optionally wherein the polyester material is present in the UV curable undercoat coating composition in an amount from 6 to 20 wt % based on the total solid weight of the composition.

79. The method according to any one of aspects 66-78, wherein the UV curable undercoat coating composition comprises from 1 to 5 wt % photoinitiator based on the total solid weight of the composition.

80. The method according to any one of aspects 66-79, further comprising the steps of: V) applying a topcoat coating composition on at least a portion of the ink layer; and VI) curing the topcoat coating composition to form a cured topcoat coating layer.

81. The method according to aspect 80, wherein the topcoat coating composition is thermally curable.

82. The method according to any one of aspects 80 or 81, wherein the topcoat coating composition comprises one or more components selected from: resin binders, solvents, crosslinker materials, and additives.

83. The method according to any one of aspects 80-82, wherein the topcoat coating composition is solvent-borne.

84. The method according to any one of aspects 82 or 83, wherein the topcoat coating composition comprises one or more resin(s) selected from a polyester resin, an acrylic resin, a polyvinyl chloride (PVC) resin, an alkyd resin, a polyurethane resins, a polysiloxane resin, an epoxy resin, or a combination thereof.

85. The method according to any one of aspects 82-84, wherein the topcoat coating composition comprises one or more crosslinker material(s) selected from phenolic resins (or phenol-formaldehyde resins); aminoplast resins (or triazine-formaldehyde resins); amino resins; epoxy resins; epoxy-mimic resins, such as those based on bisphenols and other bisphenol A (BPA) replacements; isocyanate resins, isocyanurate resins, such as triglycidylisocyanurate; hydroxy (alkyl) amide resins, such as β-hydroxy (alkyl) amide resins; hydroxy (alkyl) urea resins; carbodiimide resins, such as polycarbodiimide resins; oxazolines; and combinations thereof.

86. The method system according to aspect 85, wherein the crosslinker material comprises a phenolic resin, an aminoplast resin, an isocyanate resin, an isocyanurate resin, or a combination thereof.

87. The method according to any one of aspects 66-86, wherein the package is a plastic package.

88. The method according to aspect 87, wherein the plastic package comprises polyethylene and/or polypropylene.

89. The method according to any one of aspects 87 or 88, wherein the plastic package comprises an extruded and/or injection moulded plastic tube, such as an extruded plastic tube.

90. A method of producing an aluminum package, such as a monobloc aerosol can and/or tube, the method comprising the steps of: III) applying an ink composition on at least a portion of an aluminum package; IV) curing the ink composition to from an ink layer; V) applying a UV curable overcoat coating composition comprising: a) an epoxy material; b) a polyol material and/or a diketone-functional material; and c) a photoinitiator on at least a portion of the ink layer; and VI) curing the overcoat coating composition to form a cured overcoat coating layer.

91. The method according to aspect 90, wherein the ink composition is applied by digital printing.

92. The method according to any one of aspects 90 or 91, wherein the UV curable overcoat coating composition has a solid content of at least 95 wt % based on the total weight of the composition.

93. The method according to any one of aspects 90-92, wherein the UV curable overcoat coating composition comprises a polyol material in an amount of at least 2 wt %, such as at least 5 wt %, such as from 5 to 30 wt %, based on the total solid weight of the composition.

94. The method according to any one of aspects 90-93, wherein the UV curable overcoat coating composition comprises a diketone-functional material, such as an acetoacetate-functional material, in an amount of at least 2 wt %, such as at least 5 wt %, such as from 5 to 30 wt %, based on the total solid weight of the composition.

95. The method according to any one of aspects 90-94, wherein the epoxy material comprises a cycloaliphatic epoxy resin.

96. The method according to any one of aspects 90-95, wherein the UV curable overcoat coating composition comprises from 55 to 85 wt % epoxy material based on the total solid weight of the composition.

97. The method according to any one of aspects 90-96, wherein the photoinitiator comprises a cationic photoinitiator.

98. The method according to any one of aspects 90-97, wherein the overcoat coating composition comprises a reactive diluent, for example a reactive diluent comprising an oxetane group.

99. The method according to any one of aspects 90-98, wherein the UV curable overcoat coating composition comprises from 1 to 10 wt % photoinitiator based on the total solid weight of the composition.

100. The method according to any one of aspects 90-99, wherein the UV curable overcoat coating composition is substantially free of polytetrafluoroethylene (PTFE).

101. The method according to any one of aspects 90-100, wherein the polyol material has a hydroxyl value (OHV) of at least 25 mg KOH/g.

102. The method according to any one of aspects 90-101, wherein the UV curable overcoat coating composition comprises a wax, for example a wax comprising a micronized wax and/or a micronized polysaccharide.

103. The method according to any one of aspects 99-102, wherein the UV curable overcoat coating composition further comprises an acrylic material.

104. The method according to aspect 103, wherein the UV curable overcoat coating composition further comprises a free-radical initiator.

105. The method according to any one of aspects 90-104, further comprising the steps of: I) applying a primer coating composition to at least a portion of the aluminium package; and II) curing the primer coating composition to form a cured primer coating layer.

106. The method according to aspect 105, wherein the ink layer is disposed directly on the primer coating layer.

107. The method according to any one of aspects 106 or 106, wherein the primer layer is disposed directly on the aluminum package.

108. The method according to any one of aspects 105-107, wherein the primer coating composition is thermally curable.

109. The method according to any one of aspects 105-108, wherein the primer coating composition comprises one or more components selected from: resin binders, solvents, crosslinker materials, and additives.

110. The method according to any one of aspects 105-109, wherein the primer coating composition is solvent-borne.

111. The method according to any one of aspects 109 or 110, wherein the primer coating composition comprises one or more resin(s) selected from a polyester resin, an acrylic resin, a polyvinyl chloride (PVC) resin, an alkyd resin, a polyurethane resins, a polysiloxane resin, an epoxy resin, or a combination thereof.

112. The method according to any one of aspects 109-111, wherein the primer coating composition comprises one or more crosslinker material(s) selected from phenolic resins (or phenol-formaldehyde resins); aminoplast resins (or triazine-formaldehyde resins); amino resins; epoxy resins; epoxy-mimic resins, such as those based on bisphenols and other bisphenol A (BPA) replacements; isocyanate resins, isocyanurate resins, such as triglycidylisocyanurate; hydroxy (alkyl) amide resins, such as β-hydroxy (alkyl) amide resins; hydroxy (alkyl) urea resins; carbodiimide resins, such as polycarbodiimide resins; oxazolines; and combinations thereof.

113. The method according to aspect 112, wherein the crosslinker material comprises a phenolic resin, an aminoplast resin, an isocyanate resin, an isocyanurate resin, or a combination thereof.

114. The method according to any one of aspects 90-113, wherein the aluminium package is a monobloc aerosol can and/or tube.

115. The method according to any one of aspects 90-114, wherein the aluminium package is for use in packaging cosmetics, food products, beverages and/or pharmaceutical products, for example in packaging cosmetics and/or pharmaceutical products.

116. A UV curable undercoat coating composition, the undercoat coating composition comprising: a) an epoxy material; b) a polyol material, the polyol material having a hydroxyl value (OHV) of at least 50 mg KOH/g, and/or a diketone-functional material; and c) a photoinitiator; wherein, when present, the polyol material is present in the undercoat coating composition in an amount of at least 2 wt % based on the total solid weight of the undercoat coating composition; wherein, when present, the diketone-functional material is present in the undercoat coating composition in an amount of at least 2 wt % based on the total solid weight of the undercoat coating composition; and wherein the solid content of the undercoat coating composition is at least 95 wt % based on the total weight of the undercoat coating composition.

117. A coating composition system, the coating composition system comprising: i) A UV curable undercoat coating composition operable to be disposed on a substrate, the undercoat coating composition comprising; a) an epoxy material; b) a polyol material, the polyol material having a hydroxyl value (OHV) of at least 50 mg KOH/g, and/or a diketone-functional material; and c) a photoinitiator; wherein, when present, the polyol material is present in the undercoat coating composition in an amount of at least 2 wt % based on the total solid weight of the undercoat coating composition; wherein, when present, the diketone-functional material is present in the undercoat coating composition in an amount of at least 2 wt % based on the total solid weight of the undercoat coating composition; and wherein the solid content of the undercoat coating composition is at least 95 wt % based on the total weight of the undercoat coating composition; ii) an ink operable to be disposed on at least a portion of the undercoat coating composition or an undercoat coating derived therefrom; and iii) optionally, an overcoat coating composition operable to be disposed on at least a portion of the ink or an ink layer derived therefrom.

118. A UV curable undercoat coating composition according to aspect 116 or a coating composition system according to aspect 117, wherein the undercoat coating composition further comprises a polyester material, the polyester material having a hydroxyl value (OHV) up to 45 mg KOH/g.

119. A UV curable undercoat coating composition according to any one of aspects 1116 or 118 or a coating composition system according to any one of aspects 117 or 118, wherein the polyol material has a hydroxyl value (OHV) of at least 100 mg KOH/g.

120. A UV curable undercoat coating composition according to any one of aspects 116, 118 or 119 or a coating composition system according to any one of aspects 117-119, wherein the polyol material has an acid value (AV) up to 10 mg KOH/g.

121. A UV curable undercoat coating composition according to any one of aspects 116 or 118-120 or a coating composition system according to any one of aspects 117-120, wherein the diketone-functional material comprises an acetoacetate-functional material.

122. A UV curable undercoat coating composition according to any one of aspects 116 or 118-121 or a coating composition system according to any one of aspects 117-121, wherein the undercoat coating composition comprises a polyol material; and wherein the undercoat coating composition comprises at least 5 wt % polyol material based on the total solid weight of the undercoat coating composition, such as from 5 to 30 wt % polyol material based on the total solid weight of the undercoat coating composition.

123. A UV curable undercoat coating composition according to any one of aspects 116 or 118-122 or a coating composition system according to any one of aspects 117-122, wherein the undercoat coating composition comprises a diketone-functional material; and wherein the undercoat coating composition comprises at least 5 wt % diketone-functional material based on the total solid weight of the undercoat coating composition, such as from 5 to 30 wt % diketone-functional material based on the total solid weight of the undercoat coating composition.

124. A UV curable undercoat coating composition according to any one of aspects 116 or 118-123 or a coating composition system according to any one of aspects 117-123, wherein the epoxy material comprises a cycloaliphatic epoxy resin.

125. A UV curable undercoat coating composition according to any one of aspects 116 or 118-124 or a coating composition system according to any one of aspects 117-124, wherein the photoinitiator comprises a cationic photoinitiator.

126. A UV curable undercoat coating composition according to any one of aspects 116 or 118-125 or a coating composition system according to any one of aspects 117-125, wherein the undercoat coating composition comprises from 55 to 85 wt % epoxy material based on the total solid weight of the undercoat coating composition.

127. A UV curable undercoat coating composition according to any one of aspects 116 or 118-126 or a coating composition system according to any one of aspects 117-126, wherein the coating composition comprises from 5 to 20 wt % polyester material based on the total solid weight of the undercoat coating composition.

128. A UV curable undercoat coating composition according to any one of aspects 116 or 118-127 or a coating composition system according to any one of aspects 117-127, wherein the coating composition comprises from 1 to 5 wt % photoinitiator based on the total solid weight of the undercoat coating composition.

129. A UV curable undercoat coating composition according to any one of aspects 116 or 118-128 or a coating composition system according to any one of aspects 117-128, wherein the polyol material has a number average molecular weight (Mn) up to 5,000 Da.

130. A UV curable undercoat coating composition according to any one of aspects 116 or 118-129 or a coating composition system according to any one of aspects 117-129, wherein the undercoat coating composition and/or coating composition system is substantially free of polytetrafluoroethylene (PTFE).

131. A plastic package coated on at least a portion thereof with an undercoat coating, the undercoat coating being derived from a UV curable undercoat coating composition according to any one of aspects 116 or 118-130.

132. A plastic package coated on at least a portion thereof with a coating system, the coating system comprising: i) an undercoat coating, the undercoat coating being derived from a UV curable undercoat coating composition according to any one of aspects 116 or 118-130; ii) an ink layer disposed on at least a portion of the undercoat coating, the ink layer being derived from an ink; and iii) optionally, an overcoat coating disposed on at least a portion of the ink layer, the overcoat coating being derived from an overcoat coating composition.

133. A method of producing a coated plastic package, the method comprising the steps of: I) applying an undercoat coating composition according to any one of aspects 116 or 118-130 to at least a portion of a plastic package; II) curing said undercoat coating composition to form a cured undercoat coating; III) digitally printing an ink on at least a portion of the undercoat coating; IV) curing the ink to from an ink layer; V) optionally, applying an overcoat coating composition on at least a portion of the ink layer; and VI) curing the overcoat coating composition, if present, to form a cured overcoat coating.

134. A plastic package according to any one of aspects 131 or 132 or a method according to aspect 133, wherein the package comprises polyethylene and/or polypropylene.

135. A plastic package according to any one of aspects 131, 132 or 134 or a method according to any one of aspects 133 or 134, wherein the package is an extruded and/or injection moulded plastic tube.

136. A plastic package according to any one of aspects 131, 132, 134 or 135 or a method according to any one of aspects 133-135, wherein the undercoat coating and/or coating system is disposed on at least a portion of an external surface of the package.

137. A plastic package according to any one of aspects 131, 132 or 134-136 or a method according to any one of aspects 133-136, wherein the undercoat coating composition is applied to a thickness of from 1 to 10 μm.

All of the features contained herein may be combined with any of the above aspects in any combination.

For a better understanding of the disclosure, and to show how the same may be carried into effect, reference will now be made, by way of example, to the following examples.

### EXAMPLES

### Undercoat Examples 1-7

UV curable undercoat examples 1-7 were prepared in accordance with the formulations in Table 1, in which:
UviCure S105 is a difunctional cycloaliphatic epoxide resin, 7-oxabicyclo[4.1.0]hept-3-ylmethyl 7-oxabicyclo[4.1.0]heptane-3-carboxylate, available from Lambson;
Tego AddBond LTW is a polyester resin having an OHV of 20-30 mg KOH/g available from Evonik;
D.E.R. 731 is a reactive diluent based on 1,4-butanediol diglycidyl ether available from Olin Epoxy;
Plastomoll DOA is di-(2-ethylhexyl) adipate, a plasticiser available from BASF.
BYK-310 is a silicone additive commercially available from Altana;
BYK-141 is a silicone additive (defoamer) available from Altana;
Speedcure 976 is a cationic photoinitiator of the sulfonium hexafluoroantimonate family available from Lambson;
Desmophen 1380 is a trifunctional polypropylene ether polyol having an OHV of 385 mg KOH/g and an AV of 0.5 mg KOH/g available from Covestro;
Desmophen 670 is a slightly branched hydroxyl-bearing polyester available from Covestro;
Capa 3031 is a very low MW trifunctional caprolactone polyol having an OHV of 560 mg KOH/g, an AV of <1 mg KOH/g and a MW of 300 g/mole, available from Perstorp;
K-flex 7301 is an acetoacetate functional reactive diluent available from King Industries;
Polyol 4290 is a caprolactone polyol tetrol having an OHV of 218 mg KOH/g, an AV of <1 mg KOH/g and a MW of 1,000 g/mole, available from Perstorp;
Boltorn H 2004 is a fatty acid modified dendritic polymer with 6 terminal hydroxyl groups having an OHV of 105-135 mg KOH/g, an AV of <7 mg KOH/g and an MW of 3,200 g/mole, available from Perstorp; and
Capa 2054 is a low MW, linear polyester diol derived from caprolactone having an OHV of 204 mg KOH/g, an AV of <0.25 mg KOH/g and an MW of 550 g/mole, available from Perstorp;

All amounts are provided in parts by weight (pbw) unless specified otherwise.

### Comparative Undercoat Examples 1 and 2

Comparative undercoat examples 1 and 2, which are UV curable, were prepared in accordance with the formulations in Table 1. All amounts are provided in parts by weight (pbw) unless specified otherwise.

### Undercoat Examples 8-7

UV curable undercoat examples 1-7 were prepared in accordance with the formulations in Table 2, in which:
Lanco TF 1780 EFC is a micronized PTFE-modified polyethylene wax available from The Lubrizol Corporation;
Capa 4104 is a polycaprolactone polyol tetrol having an OHV of 218 mg KOH/g, an AV of <0.1 mg KOH/g and an MW of 1,000 g/mole, available from Perstorp;
K-flex XM B301 is an acetoacetate functional reactive diluent having an OHV of 190 mg KOH/g, available from King Industries;
K-flex 337 BA is an aliphatic saturated polyester diol having an OHV of 220 mg KOH/g, available from King Industries; and
Nebores VAGH is a vinyl resin available from Safic-Alcan.

The remining components are as described above in relation to Table 1 (and undercoat examples 1-8 and/or comparative undercoat examples 1-2).

All amounts are provided in parts by weight (pbw) unless specified otherwise.

### Comparative Undercoat Examples 3-5

Comparative undercoat examples 3-5, which are UV curable, were prepared in accordance with the formulations in Table 2. All amounts are provided in parts by weight (pbw) unless specified otherwise.

TABLE 1
Formulation of undercoat examples 1-7 and comparative undercoat examples 1 and 2

| | | | | | | | | Comparative | |
|---|---|---|---|---|---|---|---|---|---|
| | Undercoat Examples | | | | | | | Undercoat Examples | |
| Component | 1 | 2 | 3 | 4 | 5 | 6 | 7 | 1 | 2 |
| UviCure S105 | 67.3 | 67.3 | 67.3 | 67.3 | 67.3 | 67.3 | 67.3 | 67.5 | 67.3 |
| Tego AddBond LTW | 12.2 | 12.2 | 12.2 | 12.2 | 12.2 | 12.2 | 12.2 | 12.2 | 24.4 |
| D.E.R. 731 | 1.5 | 1.5 | 1.5 | 1.5 | 1.5 | 1.5 | 1.5 | 2.5 | 1.5 |
| Plastomoll DOA | 1.8 | 1.8 | 1.8 | 1.8 | 1.8 | 1.8 | 1.8 | 1.8 | 1.8 |
| BYK-310 | 0.2 | 0.2 | 0.2 | 0.2 | 0.2 | 0.2 | 0.2 | 0.2 | 0.2 |
| BYK-141 | 0.1 | 0.1 | 0.1 | 0.1 | 0.1 | 0.1 | 0.1 | 0.1 | 0.1 |
| Speedcure 976 | 3.0 | 3.0 | 3.0 | 3.0 | 3.0 | 3.0 | 3.0 | 3.0 | 3.0 |
| Desmophen 1380 | — | — | — | 12.2 | — | — | — | — | — |
| Desmophen 670 | — | — | 12.2 | — | — | — | — | — | — |
| Capa 3031 | 12.2 | — | — | — | — | — | — | — | — |
| K-flex 7301 | — | — | — | — | 12.2 | — | — | — | — |
| Polyol 4290 | — | 12.2 | — | — | — | — | — | — | — |
| Boltorn H 2004 | — | — | — | — | — | 12.2 | — | — | — |
| Capa 2054 | — | — | — | — | — | — | 12.2 | — | — |
| Total | 98.4 | 98.4 | 98.4 | 98.4 | 98.4 | 98.4 | 98.4 | 87.2 | 98.4 |

TABLE 2
Formulation of undercoat examples 8-14 and comparative undercoat examples 3-5

| | | | | | | | | Comparative Undercoat | | |
|---|---|---|---|---|---|---|---|---|---|---|
| | Undercoat Examples | | | | | | | Examples | | |
| Component | 8 | 9 | 10 | 11 | 12 | 13 | 14 | 3 | 4 | 5 |
| UviCure S105 | 67.3 | 67.3 | 67.3 | 67.3 | 67.3 | 67.3 | 67.3 | 67.3 | 67.3 | 67.3 |
| Lanco TF 1780 EFC | 0.6 | 0.6 | 0.6 | 0.6 | 0.6 | 0.6 | 0.6 | 0.6 | 0.6 | 0.6 |
| D.E.R. 731 | 1.5 | 1.5 | 1.5 | 1.5 | 1.5 | 1.5 | 1.5 | 1.5 | 1.5 | 1.5 |
| Plastomoll DOA | 1.8 | 1.8 | 1.8 | 1.8 | 1.8 | 1.8 | 1.8 | 1.8 | 1.8 | 1.8 |
| BYK-310 | 0.2 | 0.2 | 0.2 | 0.2 | 0.2 | 0.2 | 0.2 | 0.2 | 0.2 | 0.2 |
| BYK-141 | 0.1 | 0.1 | 0.1 | 0.1 | 0.1 | 0.1 | 0.1 | 0.1 | 0.1 | 0.1 |
| Speedcure 976 | 3.0 | 3.0 | 3.0 | 3.0 | 3.0 | 3.0 | 3.0 | 3.0 | 3.0 | 3.0 |
| Desmophen 1380 | 24.5 | — | — | — | — | — | — | — | — | — |
| Desmophen 670 | — | 24.5 | — | — | — | — | — | — | — | — |
| Capa 3031 | — | — | 24.5 | — | — | — | — | — | — | — |
| K-flex 7301 | — | — | — | 24.5 | — | — | — | — | — | — |
| Capa 4104 | — | — | — | — | 24.5 | — | — | — | — | — |
| K-flex XM B301 | — | — | — | — | — | 24.5 | — | — | — | — |
| K-flex 337 BA | — | — | — | — | — | — | 24.5 | — | — | — |
| Tego Addbond LTW | — | — | — | — | — | — | — | — | 24.5 | — |
| Nabores VAGH | — | — | — | — | — | — | — | — | — | 24.5 |
| Total | 99.0 | 99.0 | 99.0 | 99.0 | 99.0 | 99.0 | 99.0 | 74.5 | 99.0 | 99.0 |

The undercoat coating compositions were tested according to the following method:

Substrate preparation: an LDPE substrate, in the form of a tube, was cleaned with methylethyl ketone (MEK), left in ambient conditions for 2 minutes and then flame-treated. Then, the coating composition was applied to the substrate using a bar coater. The coating compositions were then cured under a Uviterno Lab BD-5025 UV light according to the manufacturer's instructions. Five coated substrates were prepared per sample. Once cured, 5 cm×5 cm pieces of the coated substrates were cut for evaluation.

Flex test: the flexibility of the coatings was tested as follows. A coated substrate was placed in a Sheen manual cupping test device with the coated side facing up. The Sheen manual cupping test device will be well known to a person skilled in the art and is a revolutionary apparatus for testing the resistivity of coatings at various stages of deformation. A manual force is applied, by rotation, to deform the test panel. The substrate was deformed in 1 mm increments by applying the appropriate number of rotations to produce the mm of deformation applied by the device (wherein 1 rotation corresponded to 1 mm of deformation). Thus, for 2, 3, 4, 5, 6 etc. mm of deformation 2, 3, 4, 5, 6 etc. rotations were applied, respectively. The coating was assessed for crack formation between rotations by applying graphite to the deformed area and assessing visually under a microscope. The mm of deformation before cracking occurred was recorded. The results are shown in Table 3.

TABLE 3
Results

| | | mm deformation/mm |
|---|---|---|
| Undercoat | 1 | 11 |
| Examples | 2 | 10 |
| | 3 | 9 |
| | 4 | 9 |
| | 5 | 10 |
| | 6 | 9 |
| | 7 | 10 |
| | 8 | 9 |
| | 9 | 7 |
| | 10 | 10 |
| | 11 | 10 |
| | 12 | 10 |
| | 13 | 9 |
| | 14 | 7 |
| Comparative | 1 | 7 |
| Undercoat | 2 | 8 |
| Examples | 3 | 3 |
| | 4 | 4 |
| | 5 | 4 |

The results show that the inventive UV curable undercoat coating compositions, i.e., those according to the disclosure, have improved flexibility compared to the comparative examples. For example, the results show that the use of a polyol material and/or a diketone-functional material have improved flexibility compared to the comparative examples (i.e., compared to coating compositions that do not contain such materials). Therefore, the inventive UV curable undercoat coating compositions are suitable for use as an undercoat coating for digital printing on a plastic substrate.

### Overcoat Example 1

UV curable overcoat example 1 was prepared in accordance with the formulation in Table4, in which:
Curalite OX is a 3-ethyl-3-oxetanemethanol reactive diluent available from Perstorp;
Speedcure 992 is a cationic photoinitiator of the sulfonium hexafluorophosphate family available from Lambson;
BYK-330 is a silicone-containing surface additive available from Altana; and.
MP 22XF is a micronized synthetic wax available from Micro Powders, Inc.

The remining components are as described above in relation to Table 1 (and undercoat examples 1-8 and/or comparative undercoat examples 1-2).

All amounts are provided in parts by weight (pbw) unless specified otherwise.

TABLE 4
Formulation of overcoat example 1

| Component | Overcoat example 1 |
|---|---|
| UviCure S105 | 63.45 |
| Curalite OX | 9.4 |
| Speedcure 992 | 4.23 |
| BYK-330 | 1.29 |
| Capa 3031 | 20.45 |
| MP 22XF | 1.18 |
| Total | 100 |

### Comparative Overcoat Example 1

Comparative overcoat example 1 is PPG4619-805/A, a solvent-borne overvarnish commercially available from PPG.

The overcoat coating compositions were tested according to the following method:

Substrate preparation: an aluminium panel (untreated) was coated with PPG4666-002A, a solvent-borne white basecoat commercially available from PPG, using a doctor knife to achieve an average film thickness of 15 microns. The panel was placed in a drying cabinet to thermally cure the basecoat for 5 minutes at a temperature of 150 °C. After cure of the basecoat, the overvarnish coating compositions were applied to the panels using a doctor knife to achieve an average film thickness of between 4 and 5 microns. The overcoat coating compositions where then cured in a Nordson Minicure UV Conveyor Curing Oven according to the manufacturer's instructions.

MEK double rubs: the number of reciprocating rubs required to remove the coating was measured using a ball of cotton wool soaked in methyl ethyl ketone (MEK).

Flexibility: A 15 cm×15 cm piece of the coated panel was cut out and placed into a die cutting machine in order to produce a club box shape with 4 different curved corners. The degree of damage was assessed visually and recorded using the following alpha-numeric scale, wherein the higher the number, the better the result and the ‘later’ the letter in the alphabet, the better the result. For example, the best result would be 5E and the worst would be 1A:

| Damage | Description | Rating |
|---|---|---|
| E | No damage detected | 5 |
| D | Very fine cracks | 4 |
| C | Fine cracks | 3 |
| B | Delamination points | 2 |
| A | Delamination | 1 |

The results are shown in Table 5.

TABLE 5
Results

| | | Comparative |
|---|---|---|
| | Overcoat | coating |
| Example | example 1 | example 1 |
| MEK double rubs | 100 | 100 |

Flexibility

| | | |
|---|---|---|
| Corner 1 | 2.5 A | 2.5 C |
| Corner 2 | 2.0 A | 2.5 C |
| Corner 3 | 1.5 C | 2.0 C |
| Corner 4 | 0.5 D | 1.0 D |

The results show that the inventive UV curable overcoat coating composition, i.e., that according to the disclosure, performed as good as, or better than, that of the comparative examples. This means that the inventive overcoat compositions are suitable for use as an overvarnish in the multi-layer coating systems of the present disclosure.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing. The disclosure extends to any novel one, or any novel combination, of the features disclosed in this specification (including any accompanying claims, abstract and drawings), or to any novel one, or any novel combination, of the steps of any method or process so disclosed.

1. A multi-layer coating system comprising:
i) an undercoat coating layer derived from a UV curable undercoat coating composition, the UV curable undercoat coating composition comprising:
a1) an epoxy material;
b1) a polyol material having a hydroxyl value (OHV) of at least 35 mg KOH/g and/or a diketone-functional material; and
c1) a cationic photoinitiator;
ii) an ink layer disposed directly on the undercoat coating layer, the ink layer being derived from an ink composition, optionally wherein the ink composition is digitally printed; and
iii) optionally, a topcoat coating layer disposed directly on the ink layer, the topcoat coating layer being derived from a topcoat coating composition.

2. The multi-layer coating system according to claim 1, wherein the UV curable undercoat coating composition has a solid content of at least 95 wt % based on the total weight of the composition.

3. The multi-layer coating system according to claim 1, wherein the UV curable undercoat coating composition comprises the polyol material in an amount of 5 to 30 wt %, based on the total solid weight of the composition; and/or wherein the UV curable undercoat coating composition comprises a diketone-functional material comprising an acetoacetate-functional material, in an amount of 5 to 30 wt %, based on the total solid weight of the composition.

4. (canceled)

5. The multi-layer coating system according to claim 1, wherein UV curable undercoat coating composition comprises from 55 to 85 wt % epoxy material based on the total solid weight of the composition, and wherein the epoxy material comprises a cycloaliphatic epoxy resin.

6. (canceled)

7. The multi-layer coating system according to claim 1, wherein the UV curable undercoat coating composition is substantially free of polytetrafluoroethylene (PTFE).

8. The multi-layer coating system according to claim 1, comprising the polyol material having a hydroxyl value (OHV) of at least 50 mg KOH/g an acid value (AV) up to 10 mg KOH/g; and/or a number average molecular weight (Mn) up to 5,000 Da.

9. The multi-layer coating system according to claim 1, wherein the UV curable undercoat coating composition further comprises a polyester material having an OHV of less than 35 mg KOH/g, wherein the polyester material having an OHV of less than 35 mg KOH/g comprises 6 to 20 wt % of the UV curable undercoat coating composition based on the total solid weight of the composition.

10. (canceled)

11. The multi-layer coating system according to claim 1, wherein the UV curable undercoat coating composition comprises from 1 to 5 wt % photoinitiator based on the total solid weight of the composition.

12. A plastic package coated on at least a portion thereof with a multi-layer coating system according to claim 1.

13. (canceled)

14. The plastic package according to claim 12, wherein the plastic package comprises polyethylene and/or polypropylene; and/or wherein the plastic package comprises an extruded and/or injection moulded plastic tube.

15. A multi-layer coating system comprising:
i) optionally a primer coating layer, the primer coating layer being derived from a primer coating composition;
ii) an ink layer disposed directly on a substrate and/or the primer coating layer, if present, the ink layer being derived from an ink composition; and
iii) an overcoat coating layer disposed directly on the ink layer, the overcoat coating layer derived from a UV curable overcoat coating composition, the UV curable overcoat coating composition comprising:
a2) an epoxy material;
b2) a polyol material and/or a diketone-functional material; and
c2) a cationic photoinitiator.

16. The multi-layer coating system according to claim 15, wherein the UV curable overcoat coating composition has a solid content of at least 95 wt % based on the total weight of the composition.

17. The multi-layer coating system according to claim 15, wherein the UV curable overcoat coating composition comprises the polyol material in an amount of 5 to 30 wt %, based on the total solid weight of the composition; and/or wherein the UV curable overcoat coating composition comprises a diketone-functional material comprising such as an acetoacetate-functional material, in an amount of 5 to 30 wt %, based on the total solid weight of the composition.

18. (canceled)

19. The multi-layer coating system according to claim 15, wherein UV curable overcoat coating composition comprises from 55 to 85 wt % epoxy material based on the total solid weight of the composition, and wherein the epoxy material comprises a cycloaliphatic epoxy resin.

20. (canceled)

21. The multi-layer coating system according to claim 15, wherein the UV curable overcoat coating composition is substantially free of polytetrafluoroethylene (PTFE).

22. The multi-layer coating system according to claim 15, wherein the UV curable undercoat coating composition comprises a polyol material having a hydroxyl value (OHV) of at least 25 mg KOH/g.

23. The multi-layer coating system according to claim 15, wherein the UV curable overcoat coating composition comprises from 1 to 10 wt % photoinitiator based on the total solid weight of the composition.

24. The multilayer coating system according to claim 15, wherein the UV curable overcoat coating composition further comprises a wax; and/or wherein the UV curable overcoat coating composition further comprises a reactive diluent comprising an oxetane group.

25. The multilayer coating system according to claim 15, wherein the UV curable overcoat coating composition further comprises a (meth)acrylate-functional material and, optionally, a free-radical initiator, such as a (meth)acrylate-functional material and a free-radical initiator.

26. An aluminium package coated on at least a portion thereof with a multi-layer coating system according to claim 15.

27. (canceled)

28. (canceled)
